(19) United States
(12) Patent Application Publication
(10) Pub. No.: US 2025/0326680 A1
(43) Pub. Date: Oct. 23, 2025

(54) GLASSES WITH HIGH REFRACTIVE INDEX AND LOW DENSITY

(71) Applicant: CORNING INCORPORATED, CORNING, NY (US)

(72) Inventors: Timothy Michael Gross, Painted Post, NY (US); Wendell Porter Weeks, JR., Rochester, NY (US)

(21) Appl. No.: 19/172,848

(22) Filed: Apr. 8, 2025

Related U.S. Application Data
(60) Provisional application No. 63/636,153, filed on Apr. 19, 2024.

(51) Int. Cl. C03C 3/062; C03C 4/00

(52) U.S. Cl. CPC C03C 3/062; C03C 4/00; C03C 2204/00

(57) ABSTRACT

A glass composition includes: from 35 mol. % to 62 mol. % TiO₂; from 6 mol. % to 30 mol. % SiO₂; from 1 mol. % to 30 mol. % BaO; and from 1 mol. % to 25 mol. % SrO. The glass composition is free or substantially-free of B₂O₃. The sum of TiO₂, Nb₂O₃, Ta₂O₅, Y₂O₃, ZrO₂, and La₂O₃ is greater than or equal to 47 mol. %. The sum of BaO, SrO, and CaO in the glass composition is from 20 mol. % to 50 mol. %. A total sum of concentrations of oxide components in the glass composition is equal to 100 mol. %.

This application claims the benefit of priority to U.S. Provisional Patent Application Ser. No. 63/636,153 filed on Apr. 19, 2024, the content of which is relied upon and incorporated herein by reference in its entirety.

### FIELD

The present specification generally relates to glass compositions and, in particular, to high refractive index glass compositions having low density.

### TECHNICAL BACKGROUND

Glass articles are a major component in augmented reality (AR) applications, serving various purposes to enable the immersive and visually enhanced experiences associated with AR. Generally, these glass articles are utilized to create compact and lightweight optical systems that enable the projection of virtual images into a user's field of view. How much light is bent or refracted as it passes through the glass articles depends on the refractive index of the glass. High refractive index glasses with low density allow for more efficient bending of light while reducing the size and weight of optical components. These properties are particularly significant in AR headsets, where comfort and portability may influence user adoption.

Accordingly, a continual need exists for glasses that have high refractive index and low density.

### SUMMARY

According to a first aspect, A1, a glass composition may comprise: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %

A second aspect A2 includes the glass composition according to the first aspect A1, wherein the glass composition is free or substantially-free of P₂O₅.

A third aspect A3 includes the glass composition according to either the first or second aspects A1 or A2, wherein the glass composition comprises greater than or equal to 36 mol. % and less than or equal to 60 mol. % TiO₂.

A fourth aspect A4 includes the glass composition according to any of the first through third aspects A1-A3, wherein the sum of TiO₂, Nb₂O₃, Ta₂O₅, Y₂O₃, ZrO₂, and La₂O₃ is greater than or equal to 48 mol. %.

A fifth aspect A5 includes the glass composition according to any of the first through fourth aspects A1-A4, wherein the glass composition comprises greater than or equal to 0.1 mol. % and less than or equal to 12 mol. % Nb₂O₃.

A sixth aspect A6 includes the glass composition according to any of the first through fifth aspects A1-A5, wherein the glass composition comprises greater than or equal to 0.1 mol. % and less than or equal to 12 mol. % Ta₂O₅.

A seventh aspect A7 includes the glass composition according to any of the first through sixth aspects A1-A6, wherein the glass composition comprises greater than or equal to 0.1 mol. % and less than or equal to 12 mol. % Y₂O₃.

An eighth aspect A8 includes the glass composition according to any of the first through seventh aspects A1-A7, wherein the glass composition comprises greater than or equal to 0.1 mol. % and less than or equal to 12 mol. % ZrO₂.

A ninth aspect A9 includes the glass composition according to any of the first through eighth aspects A1-A8, wherein the glass composition comprises greater than or equal to 0.1 mol. % and less than or equal to 12 mol. % La₂O₃.

A tenth aspect A10 includes the glass composition according to any of the first through ninth aspects A1-A9, wherein RO is greater than 25 mol. % and less than or equal to 40 mol. %.

An eleventh aspect A11 includes the glass composition according to any of the first through tenth aspects A1-A10, wherein the glass composition comprises greater than or equal to 6 mol. % and less than or equal to 25 mol. % BaO.

A twelfth aspect A12 includes the glass composition according to any of the first through eleventh aspects A1-A11, wherein the glass composition comprises greater than or equal to 2 mol. % and less than or equal to 23 mol. % SrO.

A thirteenth aspect A13 includes the glass composition according to any of the first through twelfth aspects A1-A12, wherein the glass composition comprises greater than 0 mol. % and less than or equal to 15 mol. % CaO.

A fourteenth aspect A14 includes the glass composition according to any of the first through thirteenth aspects A1-A13, wherein the glass composition comprises greater than or equal to 10 mol. % and less than or equal to 23 mol. % SiO₂.

A fifteenth aspect A15 includes the glass composition according to any of the first through fourteenth aspects A1-A14, wherein the glass composition comprises: greater than or equal to 37 mol. % and less than or equal to 52 mol. % TiO₂; greater than or equal to 18 mol. % and less than or equal to 23 mol. % SiO₂; greater than or equal to 8 mol. % and less than or equal to 25 mol. % BaO; and greater than or equal to 2 mol. % and less than or equal to 20 mol. % SrO.

According to a sixteenth aspect, A16, a glass article may comprise the glass composition according to any of the first through fifteenth aspects A1-A15, wherein the glass article comprises: a refractive index (n_{d}) at 589.3 nm greater than or equal to 1.97, and a density less than 4.8 g/cm³.

According to a seventeenth aspect, A17, a glass composition may comprise: greater than or equal to 38 mol. % and less than or equal to 50 mol. % TiO₂; greater than or equal to 19 mol. % and less than or equal to 22 mol. % SiO₂; greater than or equal to 10 mol. % and less than or equal to 20 mol. % BaO; and greater than or equal to 2 mol. % and less than or equal to 17 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 49 mol. %, RO is greater than or equal to 27 mol. % and less than or equal to 31 mol. %, wherein RO is the sum of BaO, SrO, and CaO; and the sum of all oxide components is equal to 100 mol. %.

An eighteenth aspect A18 includes the glass composition according to the seventeenth aspect A17, wherein the glass composition is free or substantially-free of P₂O₅.

A nineteenth aspect A19 includes the glass composition according to either the seventeenth or eighteenth aspects A17 or A18, wherein the sum of TiO₂, Nb₂O₃, Ta₂O₅, Y₂O₃, ZrO₂, and La₂O₃ is greater than or equal to 50 mol. %.

A twentieth aspect A20 includes the glass composition according to any of the seventeenth through nineteenth aspects A17-A19, wherein the glass article comprises greater than or equal to 0.1 mol. % and less than or equal to 10 mol. % Nb₂O₃.

A twenty-first aspect A21 includes the glass composition according to any of the seventeenth through twentieth aspects A17-A20, wherein the glass article comprises greater than or equal to 0.1 mol. % and less than or equal to 6 mol. % Ta₂O₅.

A twenty-second aspect A22 includes the glass composition according to any of the seventeenth through twenty-first aspects A17-A21, wherein the glass article comprises greater than or equal to 0.1 mol. % and less than or equal to 6 mol. % Y₂O₃.

A twenty-third aspect A23 includes the glass composition according to any of the seventeenth through twenty-second aspects A17-A22, wherein the glass article comprises greater than or equal to 0.1 mol. % and less than or equal to 6 mol. % ZrO₂.

A twenty-fourth aspect A24 includes the glass composition according to any of the seventeenth through twenty-third aspects A17-A23, wherein the glass article comprises greater than or equal to 0.1 mol. % and less than or equal to 6 mol. % La₂O₃.

A twenty-fifth aspect A25 includes the glass composition according to any of the seventeenth through twenty-fourth aspects A17-A24, wherein RO is greater than 28 mol. % and less than or equal to 30 mol. %.

A twenty-sixth aspect A26 includes the glass composition according to any of the seventeenth through twenty-fifth aspects A17-A25, wherein the glass composition comprises greater than or equal to 46 mol. % and less than or equal to 50 mol. % TiO₂.

A twenty-seventh aspect A27 includes the glass composition according to any of the seventeenth through twenty-sixth aspects A17-A26, wherein the glass article comprises greater than or equal to 2 mol. % and less than or equal to 12 mol. % SrO.

A twenty-eighth aspect A28 includes the glass composition according to any of the seventeenth through twenty-seventh aspects A17-A27, wherein the glass article comprises greater than 0 mol. % and less than or equal to 10 mol. % CaO.

According to a twenty-ninth aspect, A29, a glass article may comprise the glass composition according to any of the first through fifteenth aspects A17-A28, wherein the glass article comprises: a refractive index (n_{d}) at 589.3 nm greater than or equal to 1.970, and a density less than 4.8 g/cm³.

According to a thirtieth aspect, A30, a glass composition may comprise: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; greater than or equal to 1 mol. % and less than or equal to 25 mol. % SrO; and greater than 0 mol. % and less than 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %.

A thirty-first aspect A31 includes the glass composition according to the thirtieth aspect A30, wherein the glass composition is free or substantially-free of P₂O₅.

A thirty-second aspect A32 includes the glass composition according to either the thirtieth or thirty-first aspects A30 or A31, wherein the glass composition comprises greater than or equal to 36 mol. % and less than or equal to 60 mol. % TiO₂.

A thirty-third aspect A33 includes the glass composition according to any of the thirtieth through thirty-second aspects A30-A32, wherein the sum of TiO₂, Nb₂O₃, Ta₂O₅, Y₂O₃, ZrO₂, and La₂O₃ is greater than or equal to 48 mol. %.

A thirty-fourth aspect A34 includes the glass composition according to any of the thirtieth through thirty-third aspects A30-A33, wherein the glass composition comprises greater than or equal to 0.1 mol. % and less than or equal to 12 mol. % Nb₂O₃.

A thirty-fifth aspect A35 includes the glass composition according to any of the thirtieth through thirty-fourth aspects A30-A34, wherein the glass composition comprises greater than or equal to 0.1 mol. % and less than or equal to 12 mol. % Ta₂O₅.

A thirty-sixth aspect A36 includes the glass composition according to any of the thirtieth through thirty-fifth aspects A30-A35, wherein the glass composition comprises greater than or equal to 0.1 mol. % and less than or equal to 12 mol. % Y₂O₃.

A thirty-seventh aspect A37 includes the glass composition according to any of the thirtieth through thirty-sixth aspects A30-A36, wherein the glass composition comprises greater than or equal to 0.1 mol. % and less than or equal to 12 mol. % ZrO₂.

A thirty-eighth aspect A38 includes the glass composition according to any of the thirtieth through thirty-seventh aspects A30-A37, wherein the glass composition comprises greater than or equal to 0.1 mol. % and less than or equal to 12 mol. % La₂O₃.

A thirty-ninth aspect A39 includes the glass composition according to any of the thirtieth through thirty-eighth aspects A30-A38, wherein the glass composition comprises greater than or equal to 1 mol. % and less than or equal to 8 mol. % B₂O₃.

A fortieth aspect A40 includes the glass composition according to any of the thirtieth through thirty-ninth aspects A30-A39, wherein RO is greater than 25 mol. % and less than or equal to 40 mol. %.

A forty-first aspect A41 includes the glass composition according to any of the thirtieth through fortieth aspects A30-A40, wherein the glass composition comprises greater than or equal to 6 mol. % and less than or equal to 25 mol. % BaO.

A forty-second aspect A42 includes the glass composition according to any of the thirtieth through forty-first aspects A30-A41, wherein the glass composition comprises greater than or equal to 2 mol. % and less than or equal to 23 mol. % SrO.

A forty-third aspect A43 includes the glass composition according to any of the thirtieth through forty-second aspects A30-A42, wherein the glass composition comprises greater than 0 mol. % and less than or equal to 15 mol. % CaO.

A forty-fourth aspect A44 includes the glass composition according to any of the thirtieth through forty-third aspects A30-A43, wherein the glass composition comprises greater than or equal to 10 mol. % and less than or equal to 25 mol. % SiO₂.

According to a forty-fifth aspect, A45, a glass article may comprise the glass composition according to any of the thirtieth through forty-fourth aspects A30-A44, wherein the glass composition comprises: greater than or equal to 37 mol. % and less than or equal to 52 mol. % TiO₂; greater than or equal to 18 mol. % and less than or equal to 23 mol. % SiO₂; greater than or equal to 8 mol. % and less than or equal to 25 mol. % BaO; and greater than or equal to 2 mol. % and less than or equal to 20 mol. % SrO.

According to a forty-sixth aspect, A46, a glass article may comprise the glass composition according to any of the thirtieth through forty-fifth aspects A30-A45, wherein the glass article comprises: a refractive index (n_{d}) at 589.3 nm greater than or equal to 1.97, and a density less than 4.8 g/cm³.

According to a forty-seventh aspect, A47, a glass article may comprise: a glass composition comprising: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO; greater than or equal to 0 mol. % and less than or equal to 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %, wherein the glass article comprises: an ultra-high refractive index (n_{d}) at 589.3 nm greater than or equal to 2.05, and a density less than 4.8 g/cm³.

Additional features and advantages of the glass compositions described herein will be set forth in the detailed description which follows, and in part will be readily apparent to those skilled in the art from that description or recognized by practicing the embodiments described herein, including the detailed description which follows, the examples, and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 is a plan view of an electronic device incorporating any of the glass articles according to one or more embodiments described herein; and

FIG. 2 is a perspective view of the electronic device of FIG. 1.

### DETAILED DESCRIPTION

Reference will now be made in detail to various embodiments of glass compositions having high refractive indices and low densities.

According to embodiments, a glass composition may comprise greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO. The glass composition is free or substantially-free of B₂O₃. A sum of TiO₂, Nb₂O₃, Ta₂O₅, Y₂O₃, ZrO₂, and La₂O₃ is greater than or equal to 47 mol. %. RO is greater than or equal to 20 mol. % and less than or equal to 50 mol. %, wherein RO is the sum of BaO, SrO, and CaO. A total sum of concentrations of oxide components in the glass composition is equal to 100 mol. %.

According to embodiments, a glass composition may comprise greater than or equal to 38 mol. % and less than or equal to 50 mol. % TiO₂; greater than or equal to 19 mol. % and less than or equal to 22 mol. % SiO₂; greater than or equal to 10 mol. % and less than or equal to 20 mol. % BaO; and greater than or equal to 2 mol. % and less than or equal to 17 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 49 mol. %, RO is greater than or equal to 27 mol. % and less than or equal to 31 mol. %, wherein RO is the sum of BaO, SrO, and CaO; and the sum of all oxide components is equal to 100 mol. %.

According to embodiments, a glass composition may comprise greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; greater than or equal to 1 mol. % and less than or equal to 25 mol. % SrO; and greater than or equal to 0 mol. % and less than 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %.

According to embodiments, a glass article may comprise a glass composition comprising: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO; and greater than or equal to 0 mol. % and less than or equal to 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %, wherein the glass article comprises: an ultra-high refractive index (n_{d}) at 589.3 nm greater than or equal to 2.05, and a density less than 4.8 g/cm³.

Various embodiments of glass compositions and glass articles formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and resultant glass articles described herein, the concentrations of constituent components (i.e., TiO₂, SiO₂, and the like) are specified in mole percent (mol. %) on an oxide basis, unless otherwise specified. A total sum of concentrations of oxide components in the glass composition is equal to 100 mol.

The term “substantially-free,” when used to describe the concentration and/or absence of a particular constituent component in a glass composition and the resultant glass article, means that the constituent component is not intentionally added to the glass composition and the resultant glass article. However, the glass composition and the resultant glass article may contain traces of the constituent component as a contaminant or tramp in amounts of less than 0.05 weight percent (wt. %). As noted herein, the remainder of the application specifies the concentrations of constituent component in mol. %. The contaminant or tramp amounts of the constituent components are listed in wt. % for manufacturing purposes and one skilled in the art would understand the contaminant and tramp amounts being listed in wt. %.

The terms “0 mol. %” and “free,” when used to describe the concentration and/or absence of a particular constituent component in a glass composition and the resultant glass article, means that the constituent component is not present in glass composition and the resultant glass article.

Refractive index, as described herein, is measured in accordance with ASTM E1967. Unless otherwise stated, refractive index as used herein means n_{d}.

Density, as described herein, is measured by the buoyancy method of ASTM C693-93.

The elastic modulus (also referred to as Young's modulus) of the glass composition, as described herein, is provided in units of gigapascals (GPa) and is measured with Brillouin scattering, as described in the Examples herein, unless otherwise indicated.

The shear modulus of the glass composition, as described herein, is provided in units of gigapascals (GPa). The shear modulus of the glass composition is measured with Brillouin scattering, as described in the Examples herein, unless otherwise indicated.

Poisson's ratio, as described herein, is measured with Brillouin scattering, as described in the Examples herein, unless otherwise indicated.

Conventional glass articles manufactured for AR applications may utilize boron oxide (B₂O₃). However, borate glasses including relatively high concentrations of B₂O₃ (e.g., greater than or equal to 10 mol. %) may have a relatively high density (e.g., greater than 4.8 g/cm³) due to the presence of higher-density components (e.g., Nb₂O₅, Ta₂O₅, and the like). A relatively high density may be undesirable for glass articles incorporated into AR headsets.

Disclosed herein are glass compositions and glass articles formed therefrom which mitigate the aforementioned problems. Specifically, the glass compositions and the resultant glass articles disclosed herein are free, substantially-free, or contain a relatively low concentration (e.g., less than or equal to 10 mol. %) of boron oxide and comprise a relatively high concentration of TiO₂ (i.e., greater than or equal to 35 mol. %), which results in glass compositions and resultant glass articles with relatively high refractive indices (i.e., greater than or equal to 1.97) and relatively low densities (i.e., less than 4.8 g/cm³).

The glass compositions and resultant glass articles described herein may be described as titanosilicate glass compositions and articles and comprise TiO₂ and SiO₂. The glass compositions and resultant glass articles described herein may also include index modifiers in addition to TiO₂, such as Nb₂O₃, Ta₂O₅, Y₂O₃, ZrO₂, and La₂O₃ in a total concentration (i.e., a sum of TiO₂, Nb₂O₃, Ta₂O₅, Y₂O₃, ZrO₂, and La₂O₃ greater than or equal to 47 mol. %) sufficient to achieve a desired refractive index (i.e., greater than or equal to 1.97). The glass compositions and resultant glass articles described herein are free, substantially-free, or contain a relatively low concentration (e.g., less than or equal to 10 mol. %) of boron oxide and instead include TiO₂. Borate glasses, including relatively high concentrations of B₂O₃ (e.g., greater than 10 mol. %) tend to include relatively higher concentrations of higher-density materials such as Nb₂O₅, La₂O₃, and/or WO₃, leading to higher density glass. However, titanosilicate glass compositions, such as those described herein, have a lower concentration of the higher-density materials, thus leading to a decreased density of the glass compositions. The glass compositions and the resultant glass articles described herein also include alkaline earth oxides, such as BaO and SrO, in a total concentration of greater than or equal to 20 mol. % and less than or equal to 50 mol. % to stabilize the titanosilicate glass compositions described herein.

TiO₂ is the primary glass former in the glass compositions described herein and may allow for relatively low densities for the resulting glass article. It was unexpectedly found that higher concentrations of TiO₂, in combination with other components described herein, did not crystallize, allowing for glass formation. The concentration of TiO₂ in the glass compositions and resultant glass articles should be sufficiently high (i.e., greater than or equal to 35 mol. %) to provide high refractive indices (i.e., greater than or equal to 1.97). The amount of TiO₂ may be limited (i.e., less than or equal to 62 mol. %) to control the density of the glass composition, as the density of pure TiO₂ or high TiO₂ glasses is undesirably high. TiO₂ may also provide resistance to solarization. Solarization or exposure to UV light may result in an undesired decrease in the transmittance of glass after irradiation with light in different wavelength regions.

Accordingly, in embodiments, the glass composition and resultant glass article may comprise greater than or equal to 35 mol. % and less than or equal to 62 mol. % TiO₂. In embodiments, In embodiments, the glass composition and resultant glass article may comprise greater than or equal to 36 mol. % and less than or equal to 60 mol. % TiO₂. In embodiments, the glass composition and resultant glass article may comprise greater than or equal to 37 mol. % and less than or equal to 52 mol. % TiO₂. In embodiments, the glass composition and resultant glass article may comprise greater than or equal to 38 mol. % and less than or equal to 50 mol. % TiO₂. In embodiments, the glass composition and resultant glass article may comprise greater than or equal to 46 mol. % and less than or equal to 50 mol. % TiO₂.

In embodiments, the concentration of TiO₂ in the glass composition and the resultant glass article may be greater than or equal to 35 mol. %, greater than or equal to 36 mol. %, greater than or equal to 37 mol. %, greater than or equal to 38 mol. %, or even greater than or equal to 40 mol. %. In embodiments, the concentration of TiO₂ in the glass composition and the resultant glass article may be less than or equal to 62 mol. %, less than or equal to 60 mol. %, less than or equal to 58 mol. %, less than or equal to 56 mol. %, less than or equal to 54 mol. %, less than or equal to 52 mol. %, less than or equal to 50 mol. %, or even less than or equal to 48 mol. %. In embodiments, the concentration of TiO₂ in the glass composition and the resultant glass article may be greater than or equal to 35 mol. % and less than or equal to 62 mol. %, greater than or equal to 35 mol. % and less than or equal to 60 mol. %, greater than or equal to 35 mol. % and less than or equal to 58 mol. %, greater than or equal to 35 mol. % and less than or equal to 56 mol. %, greater than or equal to 35 mol. % and less than or equal to 54 mol. %, greater than or equal to 35 mol. % and less than or equal to 52 mol. %, greater than or equal to 35 mol. % and less than or equal to 50 mol. %, greater than or equal to 35 mol. % and less than or equal to 48 mol. %, greater than or equal to 36 mol. % and less than or equal to 62 mol. %, greater than or equal to 36 mol. % and less than or equal to 60 mol. %, greater than or equal to 36 mol. % and less than or equal to 58 mol. %, greater than or equal to 36 mol. % and less than or equal to 56 mol. %, greater than or equal to 36 mol. % and less than or equal to 54 mol. %, greater than or equal to 36 mol. % and less than or equal to 52 mol. %, greater than or equal to 36 mol. % and less than or equal to 50 mol. %, greater than or equal to 36 mol. % and less than or equal to 48 mol. %, greater than or equal to 38 mol. % and less than or equal to 62 mol. %, greater than or equal to 38 mol. % and less than or equal to 60 mol. %, greater than or equal to 38 mol. % and less than or equal to 58 mol. %, greater than or equal to 38 mol. % and less than or equal to 56 mol. %, greater than or equal to 38 mol. % and less than or equal to 54 mol. %, greater than or equal to 38 mol. % and less than or equal to 52 mol. %, greater than or equal to 38 mol. % and less than or equal to 50 mol. %, greater than or equal to 38 mol. % and less than or equal to 48 mol. %, greater than or equal to 40 mol. % and less than or equal to 62 mol. %, greater than or equal to 40 mol. % and less than or equal to 60 mol. %, greater than or equal to 40 mol. % and less than or equal to 58 mol. %, greater than or equal to 40 mol. % and less than or equal to 56 mol. %, greater than or equal to 40 mol. % and less than or equal to 54 mol. %, greater than or equal to 40 mol. % and less than or equal to 52 mol. %, greater than or equal to 40 mol. % and less than or equal to 50 mol. %, or even greater than or equal to 40 mol. % and less than or equal to 48 mol. %, or any and all sub-ranges formed from any of these endpoints.

SiO₂ is the secondary glass former in the glass compositions described herein and may function to stabilize the network structure of the glass articles. The concentration of SiO₂ in the glass compositions and resultant glass articles should be sufficiently high (i.e., greater than or equal to 6 mol. %) to provide some stabilization to the network structure of the resultant glass articles. The amount of SiO₂ may be limited (i.e., less than or equal to 30 mol. %) to control the melting point of the glass composition, as the melting temperature of pure SiO₂ or high SiO₂ glasses is undesirably high. Thus, limiting the concentration of SiO₂ may aid in improving the meltability and the formability of the resulting glass article.

Accordingly, in embodiments, the glass composition and resultant glass article may comprise greater than or equal to 6 mol. % and less than or equal to 30 mol. % SiO₂. In embodiments, the glass composition and resultant glass article may comprise greater than or equal to 10 mol. % and less than or equal to 25 mol. % SiO₂. In embodiments, the glass composition and resultant glass article may comprise greater than or equal to 18 mol. % and less than or equal to 23 mol. % SiO₂. In embodiments, the glass composition and resultant glass article may comprise greater than or equal to 19 mol. % and less than or equal to 22 mol. % SiO₂. In embodiments, the concentration of SiO₂ in the glass composition and the resultant glass article may be greater than or equal to 6 mol. %, greater than or equal to 10 mol. %, greater than or equal to 15 mol. %, or even greater than or equal to 20 mol. %. In embodiments, the concentration of SiO₂ in the glass composition and the resultant glass article may be less than or equal to 30 mol. %, less than or equal to 27 mol. %, less than or equal to 25 mol. %, less than or equal to 23 mol. %, or even less or equal to 21 mol. %. In embodiments, the concentration of SiO₂ in the glass composition and the resultant glass article may be greater than or equal to 6 mol. % and less than or equal to 30 mol. %, greater than or equal to 6 mol. % and less than or equal to 27 mol. %, greater than or equal to 6 mol. % and less than or equal to 25 mol. %, greater than or equal to 6 mol. % and less than or equal to 23 mol. %, greater than or equal to 6 mol. % and less than or equal to 21 mol. %, greater than or equal to 10 mol. % and less than or equal to 30 mol. %, greater than or equal to 10 mol. % and less than or equal to 27 mol. %, greater than or equal to 10 mol. % and less than or equal to 25 mol. %, greater than or equal to 10 mol. % and less than or equal to 23 mol. %, greater than or equal to 10 mol. % and less than or equal to 21 mol. %, greater than or equal to 15 mol. % and less than or equal to 30 mol. %, greater than or equal to 15 mol. % and less than or equal to 27 mol. %, greater than or equal to 15 mol. % and less than or equal to 25 mol. %, greater than or equal to 15 mol. % and less than or equal to 23 mol. %, greater than or equal to 15 mol. % and less than or equal to 21 mol. %, greater than or equal to 20 mol. % and less than or equal to 30 mol. %, greater than or equal to 20 mol. % and less than or equal to 27 mol. %, greater than or equal to 20 mol. % and less than or equal to 25 mol. %, greater than or equal to 20 mol. % and less than or equal to 23 mol. %, or even greater than or equal to 20 mol. % and less than or equal to 21 mol. %, or any and all sub-ranges formed from any of these endpoints.

As described hereinabove, the glass compositions and the resultant glass article may contain alkaline earth oxides (i.e., BaO and SrO) to further stabilize the glass composition and improve formability of the resultant glass article. The alkaline earth oxides are modifiers and do not participate in the glass network. In embodiments, the concentration of BaO in the glass composition and the resultant glass article may be greater than or equal to 1 mol. % and less than or equal to 30 mol. %. In embodiments, the concentration of BaO in the glass composition and the resultant glass article may be greater than or equal to 6 mol. % and less than or equal to 25 mol. %. In embodiments, the concentration of BaO in the glass composition and the resultant glass article may be greater than or equal to 8 mol. % and less than or equal to 25 mol. %. In embodiments, the concentration of BaO in the glass composition and the resultant glass article may be greater than or equal to 10 mol. % and less than or equal to 20 mol. %. In embodiments, the concentration of BaO in the glass composition and the resultant glass article may be greater than or equal to 1 mol. %, greater than or equal to 3 mol. %, greater than or equal to 6 mol. %, greater than or equal to 9 mol. %, greater than or equal to 12 mol. %, or even greater than or equal to 15 mol. %. In embodiments, the concentration of BaO in the glass composition and the resultant glass article may be less than or equal to 30 mol. %, less than or equal to 25 mol. %, less than or equal to 20 mol. %, or even less than or equal to 15 mol. %. In embodiments, the concentration of BaO in the glass composition and the resultant glass article may be greater than or equal to 1 mol. % and less than or equal to 30 mol. %, greater than or equal to 1 mol. % and less than or equal to 25 mol. %, greater than or equal to 1 mol. % and less than or equal to 20 mol. %, greater than or equal to 1 mol. % and less than or equal to 15 mol. %, greater than or equal to 3 mol. % and less than or equal to 30 mol. %, greater than or equal to 3 mol. % and less than or equal to 25 mol. %, greater than or equal to 3 mol. % and less than or equal to 20 mol. %, greater than or equal to 3 mol. % and less than or equal to 15 mol. %, greater than or equal to 6 mol. % and less than or equal to 30 mol. %, greater than or equal to 6 mol. % and less than or equal to 25 mol. %, greater than or equal to 6 mol. % and less than or equal to 20 mol. %, greater than or equal to 6 mol. % and less than or equal to 15 mol. %, greater than or equal to 9 mol. % and less than or equal to 30 mol. %, greater than or equal to 9 mol. % and less than or equal to 25 mol. %, greater than or equal to 9 mol. % and less than or equal to 20 mol. %, greater than or equal to 9 mol. % and less than or equal to 15 mol. %, greater than or equal to 12 mol. % and less than or equal to 30 mol. %, greater than or equal to 12 mol. % and less than or equal to 25 mol. %, greater than or equal to 12 mol. % and less than or equal to 20 mol. %, greater than or equal to 12 mol. % and less than or equal to 15 mol. %, greater than or equal to 15 mol. % and less than or equal to 30 mol. %, greater than or equal to 15 mol. % and less than or equal to 25 mol. %, or even greater than or equal to 15 mol. % and less than or equal to 20 mol. %, or any and all sub-ranges formed from any of these endpoints.

In embodiments, the concentration of SrO in the glass composition and the resultant glass article may be greater than or equal to 1 mol. % and less than or equal to 25 mol. %. In embodiments, the concentration of SrO in the glass composition and the resultant glass article may be greater than or equal to 2 mol. % and less than or equal to 23 mol. %. In embodiments, the concentration of SrO in the glass composition and the resultant glass article may be greater than or equal to 2 mol. % and less than or equal to 20 mol. %. In embodiments, the concentration of SrO in the glass composition and the resultant glass article may be greater than or equal to 2 mol. % and less than or equal to 17 mol. %. In embodiments, the concentration of SrO in the glass composition and the resultant glass article may be greater than or equal to 2 mol. % and less than or equal to 12 mol. %. In embodiments, the concentration of SrO in the glass composition and the resultant glass article may be greater than or equal to 1 mol. %, greater than or equal to 2 mol. %, greater than or equal to 4 mol. %, greater than or equal to 6 mol. %, or even greater than or equal to 8 mol. %. In embodiments, the concentration of SrO in the glass composition and the resultant glass article may be less than or equal to 25 mol. %, less than or equal to 20 mol. %, less than or equal to 15 mol. %, less than or equal to 10 mol. %, or even less than or equal to 5 mol. %. In embodiments, the concentration of SrO in the glass composition and the resultant glass article may be greater than or equal to 1 mol. % and less than or equal to 25 mol. %, greater than or equal to 1 mol. % and less than or equal to 20 mol. %, greater than or equal to 1 mol. % and less than or equal to 15 mol. %, greater than or equal to 1 mol. % and less than or equal to 10 mol. %, greater than or equal to 1 mol. % and less than or equal to 5 mol. %, greater than or equal to 2 mol. % and less than or equal to 25 mol. %, greater than or equal to 2 mol. % and less than or equal to 20 mol. %, greater than or equal to 2 mol. % and less than or equal to 15 mol. %, greater than or equal to 2 mol. % and less than or equal to 10 mol. %, greater than or equal to 2 mol. % and less than or equal to 5 mol. %, greater than or equal to 4 mol. % and less than or equal to 25 mol. %, greater than or equal to 4 mol. % and less than or equal to 20 mol. %, greater than or equal to 4 mol. % and less than or equal to 15 mol. %, greater than or equal to 4 mol. % and less than or equal to 10 mol. %, greater than or equal to 4 mol. % and less than or equal to 5 mol. %, greater than or equal to 6 mol. % and less than or equal to 25 mol. %, greater than or equal to 6 mol. % and less than or equal to 20 mol. %, greater than or equal to 6 mol. % and less than or equal to 15 mol. %, greater than or equal to 6 mol. % and less than or equal to 10 mol. %, greater than or equal to 8 mol. % and less than or equal to 25 mol. %, greater than or equal to 8 mol. % and less than or equal to 20 mol. %, greater than or equal to 8 mol. % and less than or equal to 15 mol. %, greater than or equal to 8 mol. % and less than or equal to 10 mol. %, or any and all sub-ranges formed from any of these endpoints.

The glass compositions and result glass articles may further include CaO. In embodiments, the glass composition and the resultant glass article may comprise greater than or equal to 0 mol. % and less than or equal to 15 mol. % CaO. In embodiments, the glass composition and the resultant glass article may comprise greater than or equal to 0 mol. % and less than or equal to 10 mol. % CaO. In embodiments, the concentration of CaO in the glass composition and the resultant glass article may be greater than or equal to 0 mol. %, greater than or equal to 3 mol. %, greater than or equal to 5 mol. %, or even greater than or equal to 7 mol. %. In embodiments, the concentration of CaO in the glass composition and the resultant glass article may be less than or equal to 15 mol. %, less than or equal to 13 mol. %, less than or equal to 10 mol. %, less than or equal to 7 mol. %, or even less than or equal to 5 mol. %. In embodiments, the concentration of CaO in the glass composition and the resultant glass article may be greater than or equal to 0 mol. % and less than or equal to 15 mol. %, greater than or equal to 0 mol. % and less than or equal to 13 mol. %, greater than or equal to 0 mol. % and less than or equal to 10 mol. %, greater than or equal to 0 mol. % and less than or equal to 7 mol. %, greater than or equal to 0 mol. % and less than or equal to 5 mol. %, greater than or equal to 3 mol. % and less than or equal to 15 mol. %, greater than or equal to 3 mol. % and less than or equal to 13 mol. %, greater than or equal to 3 mol. % and less than or equal to 10 mol. %, greater than or equal to 3 mol. % and less than or equal to 7 mol. %, greater than or equal to 3 mol. % and less than or equal to 5 mol. %, greater than or equal to 5 mol. % and less than or equal to 15 mol. %, greater than or equal to 5 mol. % and less than or equal to 13 mol. %, greater than or equal to 5 mol. % and less than or equal to 10 mol. %, greater than or equal to 5 mol. % and less than or equal to 7 mol. %, greater than or equal to 7 mol. % and less than or equal to 15 mol. %, greater than or equal to 7 mol. % and less than or equal to 13 mol. %, or even greater than or equal to 7 mol. % and less than or equal to 10 mol. %, or any and all sub-ranges formed from any of these endpoints. In embodiments, the glass composition and the resultant glass article may be free or substantially-free of CaO.

RO is the sum (in mol. %) of BaO, SrO, and CaO present in the glass composition and the resultant glass article (i.e., RO=BaO (mol. %)+SrO (mol. %)+CaO (mol. %)). In embodiments, the concentration of RO in the glass composition and the resultant glass article may be greater than or equal to 20 mol. % and less than or equal to 50 mol. %. In embodiments, the concentration of RO in the glass composition and the resultant glass article may be greater than or equal to 25 mol. % and less than or equal to 40 mol. %. In embodiments, the concentration of RO in the glass composition and the resultant glass article may be greater than or equal to 27 mol. % and less than or equal to 31 mol. %. In embodiments, the concentration of RO in the glass composition and the resultant glass article may be greater than or equal to 28 mol. % and less than or equal to 30 mol. %. In embodiments, the concentration of RO in the glass composition and the resultant glass article may be greater than or equal to 20 mol. %, greater than or equal to 25 mol. %, greater than or equal to 27 mol. %, or even greater than or equal to 30 mol. %. In embodiments, the concentration of RO in the glass composition and the resultant glass article may be less than or equal to 50 mol. %, less than or equal to 45 mol. %, less than or equal to 40 mol. %, less than or equal to 35 mol. %, or even less than or equal to 30 mol. %. In embodiments, the concentration of RO in the glass composition and the resultant glass article may be greater than or equal to 20 mol. % and less than or equal to 50 mol. %, greater than or equal to 20 mol. % and less than or equal to 45 mol. %, greater than or equal to 20 mol. % and less than or equal to 40 mol. %, greater than or equal to 20 mol. % and less than or equal to 35 mol. %, greater than or equal to 20 mol. % and less than or equal to 30 mol. %, greater than or equal to 25 mol. % and less than or equal to 50 mol. %, greater than or equal to 25 mol. % and less than or equal to 45 mol. %, greater than or equal to 25 mol. % and less than or equal to 40 mol. %, greater than or equal to 25 mol. % and less than or equal to 35 mol. %, greater than or equal to 25 mol. % and less than or equal to 30 mol. %, greater than or equal to 27 mol. % and less than or equal to 50 mol. %, greater than or equal to 27 mol. % and less than or equal to 45 mol. %, greater than or equal to 27 mol. % and less than or equal to 40 mol. %, greater than or equal to 27 mol. % and less than or equal to 35 mol. %, greater than or equal to 27 mol. % and less than or equal to 30 mol. %, greater than or equal to 30 mol. % and less than or equal to 50 mol. %, greater than or equal to 30 mol. % and less than or equal to 45 mol. %, greater than or equal to 30 mol. % and less than or equal to 40 mol. %, or even greater than or equal to 30 mol. % and less than or equal to 35 mol. %, or any and all sub-ranges formed from any of these endpoints.

The glass compositions and resultant glass articles described herein may also include B₂O₃. In embodiments, where B₂O₃ is present, the B₂O₃ may act as a network modifier in the glass composition. As described herein, borate glasses including relatively high concentrations of B₂O₃ (e.g., greater than 10 mol. %) tend to include relatively higher concentrations of higher-density materials such as Nb₂O₅, La₂O₃, and/or WO₃, leading to higher density glass. As such, the amount of B₂O₃ included in the glass compositions and the resultant glass articles described herein may be limited (e.g., less than or equal to 10 mol. %). The glass composition and the resultant glass article may comprise greater than or equal to 0 mol. % and less than or equal to 10 mol. % B₂O₃. The glass composition and the resultant glass article may comprise greater than or equal to 1 mol. % and less than or equal to 8 mol. % B₂O₃. In embodiments, the concentration of B₂O₃ in the glass composition and the resultant glass article may be greater than or equal to 0 mol. %, greater than or equal to 1 mol. %, greater than or equal to 3 mol. %, or even greater than or equal to 5 mol. %. In embodiments, the concentration of B₂O₃ in the glass composition and the resultant glass article may be less than or equal to 10 mol. %, less than or equal to 8 mol. %, less than or equal to 6 mol. %, less than or equal to 4 mol. %, or even less than or equal to 2 mol. %. In embodiments, the concentration of B₂O₃ in the glass composition and the resultant glass article may be greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0 mol. % and less than or equal to 4 mol. %, greater than or equal to 0 mol. % and less than or equal to 2 mol. %, greater than or equal to 1 mol. % and less than or equal to 10 mol. %, greater than or equal to 1 mol. % and less than or equal to 8 mol. %, greater than or equal to 1 mol. % and less than or equal to 6 mol. %, greater than or equal to 1 mol. % and less than or equal to 4 mol. %, greater than or equal to 1 mol. % and less than or equal to 2 mol. %, greater than or equal to 3 mol. % and less than or equal to 10 mol. %, greater than or equal to 3 mol. % and less than or equal to 8 mol. %, greater than or equal to 3 mol. % and less than or equal to 6 mol. %, greater than or equal to 3 mol. % and less than or equal to 4 mol. %, greater than or equal to 5 mol. % and less than or equal to 10 mol. %, greater than or equal to 5 mol. % and less than or equal to 8 mol. %, or even greater than or equal to 5 mol. % and less than or equal to 6 mol. %, or any and all sub-ranges formed from any of these endpoints. In embodiments, the glass compositions and the resultant glass articles described herein are free or substantially-free of B₂O₃.

The glass compositions and resultant glass articles described herein may also include index modifiers in addition to TiO₂, such as Nb₂O₃, Ta₂O₅, Y₂O₃, ZrO₂, and La₂O₃, to achieve a desired refractive index (i.e., greater than or equal to 1.97). Without being bound by any theory, it is believed that there may be a correlation between the amount of index modifiers in a given glass composition and the refractive index of the glass. For example, as described herein, the addition of index modifiers such as Nb₂O₃, Ta₂O₅, Y₂O₃, ZrO₂, and La₂O₃ to TiO₂ in an amount of at least 47 mol. % results in resultant glass article having a relatively high refractive index (i.e., greater than or equal to 1.97).

In embodiments, the sum of TiO₂, Nb₂O₃, Ta₂O₅, Y₂O₃, ZrO₂, and La₂O₃ in the glass composition and resultant glass article may be greater than or equal to 47 mol. %, greater than or equal to 48 mol. %, greater than or equal to 49 mol. %, or even greater than or equal to 50 mol. %. In embodiments, the sum of TiO₂, Nb₂O₃, Ta₂O₅, Y₂O₃, ZrO₂, and La₂O₃ in the glass composition and resultant glass article may be less than or equal to 70 mol. %, less than or equal to 65 mol. %, or even less than or equal to 60 mol. %. In embodiments, the sum of TiO₂, Nb₂O₃, Ta₂O₅, Y₂O₃, ZrO₂, and La₂O₃ in the glass composition and resultant glass article may be greater than or equal to 47 mol. % and less than or equal to 70 mol. %, greater than or equal to 47 mol. % and less than or equal to 65 mol. %, greater than or equal to 47 mol. % and less than or equal to 60 mol. %, greater than or equal to 48 mol. % and less than or equal to 70 mol. %, greater than or equal to 48 mol. % and less than or equal to 65 mol. %, greater than or equal to 48 mol. % and less than or equal to 60 mol. %, greater than or equal to 49 mol. % and less than or equal to 70 mol. %, greater than or equal to 49 mol. % and less than or equal to 65 mol. %, greater than or equal to 49 mol. % and less than or equal to 60 mol. %, greater than or equal to 50 mol. % and less than or equal to 70 mol. %, greater than or equal to 50 mol. % and less than or equal to 65 mol. %, or even greater than or equal to 50 mol. % and less than or equal to 60 mol. %, or any and all sub-ranges formed from any of these endpoints.

In embodiments, the concentration of Nb₂O₃ in the glass composition and the resultant glass article may be greater than or equal to 0.1 mol. % and less than or equal to 12 mol. %. In embodiments, the concentration of Nb₂O₃ in the glass composition and the resultant glass article may be greater than or equal to 0.1 mol. % and less than or equal to 10 mol. %. In embodiments, the concentration of Nb₂O₃ in the glass composition and the resultant glass article may be greater than or equal to 0 mol. %, greater than or equal to 0.1 mol. %, greater than or equal to 0.5 mol. %, greater than or equal to 1 mol. %, greater than or equal to 3 mol. %, or even greater than or equal to 5 mol. %. In embodiments, the concentration of Nb₂O₃ in the glass composition and the resultant glass article may be less than or equal to 12 mol. %, less than or equal to 10 mol. %, less than or equal to 8 mol. %, or even less than or equal to 6 mol. %. In embodiments, the concentration of Nb₂O₃ in the glass composition and the resultant glass article may be greater than or equal to 0 mol. % and less than or equal to 12 mol. %, greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0.1 mol. % and less than or equal to 12 mol. %, greater than or equal to 0.1 mol. % and less than or equal to 10 mol. %, greater than or equal to 0.1 mol. % and less than or equal to 8 mol. %, greater than or equal to 0.1 mol. % and less than or equal to 6 mol. %, greater than or equal to 0.5 mol. % and less than or equal to 12 mol. %, greater than or equal to 0.5 mol. % and less than or equal to 10 mol. %, greater than or equal to 0.5 mol. % and less than or equal to 8 mol. %, greater than or equal to 0.5 mol. % and less than or equal to 6 mol. %, greater than or equal to 1 mol. % and less than or equal to 12 mol. %, greater than or equal to 1 mol. % and less than or equal to 10 mol. %, greater than or equal to 1 mol. % and less than or equal to 8 mol. %, greater than or equal to 1 mol. % and less than or equal to 6 mol. %, greater than or equal to 3 mol. % and less than or equal to 12 mol. %, greater than or equal to 3 mol. % and less than or equal to 10 mol. %, greater than or equal to 3 mol. % and less than or equal to 8 mol. %, greater than or equal to 3 mol. % and less than or equal to 6 mol. %, greater than or equal to 5 mol. % and less than or equal to 12 mol. %, greater than or equal to 5 mol. % and less than or equal to 10 mol. %, greater than or equal to 5 mol. % and less than or equal to 8 mol. %, or even greater than or equal to 5 mol. % and less than or equal to 6 mol. %, or any and all sub-ranges formed from any of these endpoints. In embodiments, the glass composition and the resultant glass article may be free or substantially-free of Nb₂O₃.

In embodiments, the glass composition and the resultant glass article may comprise greater than or equal to 0 mol. % and less than or equal to 12 mol. % Ta₂O₅. In embodiments, the glass composition and the resultant glass article may comprise greater than or equal to 0.1 mol. % and less than or equal to 6 mol. % Ta₂O₅. In embodiments, the concentration of Ta₂O₅ in the glass composition and the resultant glass article may be greater than or equal to 0 mol. %, greater than or equal to 0.1 mol. %, greater than or equal to 0.5 mol. %, or even greater than or equal to 1 mol. %. In embodiments, the concentration of Ta₂O₅ in the glass composition and the resultant glass article may be less than or equal to 12 mol. %, less than or equal to 10 mol. %, less than or equal to 8 mol. %, less than or equal to 6 mol. %, less than or equal to 4 mol. %, or even less than or equal to 2 mol. %. In embodiments, the concentration of Ta₂O₅ in the glass composition and the resultant glass article may be greater than or equal to 0 mol. % and less than or equal to 12 mol. %, greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0 mol. % and less than or equal to 4 mol. %, greater than or equal to 0 mol. % and less than or equal to 2 mol. %, greater than or equal to 0.1 mol. % and less than or equal to 12 mol. %, greater than or equal to 0.1 mol. % and less than or equal to 10 mol. %, greater than or equal to 0.1 mol. % and less than or equal to 8 mol. %, greater than or equal to 0.1 mol. % and less than or equal to 6 mol. %, greater than or equal to 0.1 mol. % and less than or equal to 4 mol. %, greater than or equal to 0.1 mol. % and less than or equal to 2 mol. %, greater than or equal to 0.5 mol. % and less than or equal to 12 mol. %, greater than or equal to 0.5 mol. % and less than or equal to 10 mol. %, greater than or equal to 0.5 mol. % and less than or equal to 8 mol. %, greater than or equal to 0.5 mol. % and less than or equal to 6 mol. %, greater than or equal to 0.5 mol. % and less than or equal to 4 mol. %, greater than or equal to 0.5 mol. % and less than or equal to 2 mol. %, greater than or equal to 1 mol. % and less than or equal to 12 mol. %, greater than or equal to 1 mol. % and less than or equal to 10 mol. %, greater than or equal to 1 mol. % and less than or equal to 8 mol. %, greater than or equal to 1 mol. % and less than or equal to 6 mol. %, greater than or equal to 1 mol. % and less than or equal to 4 mol. %, or even greater than or equal to 1 mol. % and less than or equal to 2 mol. %, or any and all sub-ranges formed from any of these endpoints. In embodiments, the glass composition and the resultant glass article may be free or substantially-free of Ta₂O₅.

In embodiments, the glass composition and the resultant glass article may comprise greater than or equal to 0 mol. % and less than or equal to 12 mol. % Y₂O₃. In embodiments, the glass composition and the resultant glass article may comprise greater than or equal to 0.1 mol. % and less than or equal to 6 mol. % Y₂O₃. In embodiments, the concentration of Y₂O₃ in the glass composition and the resultant glass article may be greater than or equal to 0 mol. %, greater than or equal to 0.1 mol. %, greater than or equal to 0.5 mol. %, greater than or equal to 1 mol. %, or even greater than or equal to 2 mol. %. In embodiments, the concentration of Y₂O₃ in the glass composition and the resultant glass article may be less than or equal to 12 mol. %, less than or equal to 10 mol. %, less than or equal to 8 mol. %, less than or equal to 6 mol. %, or even less than or equal to 4 mol. %. In embodiments, the concentration of Y₂O₃ in the glass composition and the resultant glass article may be greater than or equal to 0 mol. % and less than or equal to 12 mol. %, greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0 mol. % and less than or equal to 4 mol. %, greater than or equal to 0.1 mol. % and less than or equal to 12 mol. %, greater than or equal to 0.1 mol. % and less than or equal to 10 mol. %, greater than or equal to 0.1 mol. % and less than or equal to 8 mol. %, greater than or equal to 0.1 mol. % and less than or equal to 6 mol. %, greater than or equal to 0.1 mol. % and less than or equal to 4 mol. %, greater than or equal to 0.5 mol. % and less than or equal to 12 mol. %, greater than or equal to 0.5 mol. % and less than or equal to 10 mol. %, greater than or equal to 0.5 mol. % and less than or equal to 8 mol. %, greater than or equal to 0.5 mol. % and less than or equal to 6 mol. %, greater than or equal to 0.5 mol. % and less than or equal to 4 mol. %, greater than or equal to 1 mol. % and less than or equal to 12 mol. %, greater than or equal to 1 mol. % and less than or equal to 10 mol. %, greater than or equal to 1 mol. % and less than or equal to 8 mol. %, greater than or equal to 1 mol. % and less than or equal to 6 mol. %, greater than or equal to 1 mol. % and less than or equal to 4 mol. %, greater than or equal to 2 mol. % and less than or equal to 12 mol. %, greater than or equal to 2 mol. % and less than or equal to 10 mol. %, greater than or equal to 2 mol. % and less than or equal to 8 mol. %, greater than or equal to 2 mol. % and less than or equal to 6 mol. %, or even greater than or equal to 2 mol. % and less than or equal to 4 mol. %, or any and all sub-ranges formed from any of these endpoints. In embodiments, the glass composition and the resultant glass article may be free or substantially-free of Y₂O₃.

In embodiments, the glass composition and the resultant glass article may comprise greater than or equal to 0 mol. % and less than or equal to 12 mol. % ZrO₂. In embodiments, the glass composition and the resultant glass article may comprise greater than or equal to 0.1 mol. % and less than or equal to 6 mol. % ZrO₂. In embodiments, the concentration of ZrO₂ in the glass composition and the resultant glass article may be greater than or equal to 0 mol. %, greater than or equal to 0.1 mol. %, or even greater than or equal to 0.5 mol. %. In embodiments, the concentration of ZrO₂ in the glass composition and the resultant glass article may be less than or equal to 12 mol. %, less than or equal to 10 mol. %, less than or equal to 8 mol. %, less than or equal to 6 mol. %, or even less than or equal to 4 mol. %. In embodiments, the concentration of ZrO₂ in the glass composition and the resultant glass article may be greater than or equal to 0 mol. % and less than or equal to 12 mol. %, greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0 mol. % and less than or equal to 4 mol. %, greater than or equal to 0.1 mol. % and less than or equal to 12 mol. %, greater than or equal to 0.1 mol. % and less than or equal to 10 mol. %, greater than or equal to 0.1 mol. % and less than or equal to 8 mol. %, greater than or equal to 0.1 mol. % and less than or equal to 6 mol. %, greater than or equal to 0.1 mol. % and less than or equal to 4 mol. %, greater than or equal to 0.5 mol. % and less than or equal to 12 mol. %, greater than or equal to 0.5 mol. % and less than or equal to 10 mol. %, greater than or equal to 0.5 mol. % and less than or equal to 8 mol. %, greater than or equal to 0.5 mol. % and less than or equal to 6 mol. %, or even greater than or equal to 0.5 mol. % and less than or equal to 4 mol. %, or any and all sub-ranges formed from any of these endpoints. In embodiments, the glass composition and the resultant glass article may be free or substantially-free of ZrO₂.

In embodiments, the glass composition and the resultant glass article may comprise greater than or equal to 0 mol. % and less than or equal to 12 mol. % La₂O₃. In embodiments, the glass composition and the resultant glass article may comprise greater than or equal to 0.1 mol. % and less than or equal to 6 mol. % La₂O₃. In embodiments, the concentration of La₂O₃ in the glass composition and the resultant glass article may be greater than or equal to 0 mol. %, greater than or equal to 0.1 mol. %, greater than or equal to 0.5 mol. %, or even greater than or equal to 1 mol. %. In embodiments, the concentration of La₂O₃ in the glass composition and the resultant glass article may be less than or equal to 12 mol. %, less than or equal to 10 mol. %, less than or equal to 8 mol. %, less than or equal to 6 mol. %, less than or equal to 4 mol. %, or even less than or equal to 2 mol. %. In embodiments, the concentration of La₂O₃ in the glass composition and the resultant glass article may be greater than or equal to 0 mol. % and less than or equal to 12 mol. %, greater than or equal to 0 mol. % and less than or equal to 10 mol. %, greater than or equal to 0 mol. % and less than or equal to 8 mol. %, greater than or equal to 0 mol. % and less than or equal to 6 mol. %, greater than or equal to 0 mol. % and less than or equal to 4 mol. %, greater than or equal to 0 mol. % and less than or equal to 2 mol. %, greater than or equal to 0.1 mol. % and less than or equal to 12 mol. %, greater than or equal to 0.1 mol. % and less than or equal to 10 mol. %, greater than or equal to 0.1 mol. % and less than or equal to 8 mol. %, greater than or equal to 0.1 mol. % and less than or equal to 6 mol. %, greater than or equal to 0.1 mol. % and less than or equal to 4 mol. %, greater than or equal to 0.1 mol. % and less than or equal to 2 mol. %, greater than or equal to 0.5 mol. % and less than or equal to 12 mol. %, greater than or equal to 0.5 mol. % and less than or equal to 10 mol. %, greater than or equal to 0.5 mol. % and less than or equal to 8 mol. %, greater than or equal to 0.5 mol. % and less than or equal to 6 mol. %, greater than or equal to 0.5 mol. % and less than or equal to 4 mol. %, greater than or equal to 0.5 mol. % and less than or equal to 2 mol. %, greater than or equal to 1 mol. % and less than or equal to 12 mol. %, greater than or equal to 1 mol. % and less than or equal to 10 mol. %, greater than or equal to 1 mol. % and less than or equal to 8 mol. %, greater than or equal to 1 mol. % and less than or equal to 6 mol. %, greater than or equal to 1 mol. % and less than or equal to 4 mol. %, or even greater than or equal to 1 mol. % and less than or equal to 2 mol. %, or any and all sub-ranges formed from any of these endpoints. In embodiments, the glass composition and the resultant glass article may be free or substantially-free of La₂O₃.

The glass compositions and the resultant glass articles described herein may be free or substantially-free of P₂O₅.

In embodiments, the glass composition may comprise: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %

In embodiments, the glass composition may comprise: greater than or equal to 45 mol. % and less than or equal to 50 mol. % TiO₂; greater than or equal to 19 mol. % and less than or equal to 22 mol. % SiO₂; greater than or equal to 10 mol. % and less than or equal to 20 mol. % BaO; and greater than or equal to 2 mol. % and less than or equal to 17 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 49 mol. %, RO is greater than or equal to 27 mol. % and less than or equal to 31 mol. %, wherein RO is the sum of BaO, SrO, and CaO; and the sum of all oxide components is equal to 100 mol. %.

In embodiments, the glass composition may comprise: greater than or equal to 38 mol. % and less than or equal to 50 mol. % TiO₂; greater than or equal to 19 mol. % and less than or equal to 22 mol. % SiO₂; greater than or equal to 10 mol. % and less than or equal to 20 mol. % BaO; and greater than or equal to 2 mol. % and less than or equal to 17 mol. % SrO, wherein: the glass composition is free or substantially-free of B₂O₃; a sum of TiO₂, Nb₂O₃, Ta₂O₅, Y₂O₃, ZrO₂, and La₂O₃ is greater than or equal to 49 mol. %, RO is greater than or equal to 27 mol. % and less than or equal to 31 mol. %, wherein RO is the sum of BaO, SrO, and CaO; and the sum of all oxide components is equal to 100 mol. %.

In embodiments, the glass composition may comprise: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; greater than or equal to 1 mol. % and less than or equal to 25 mol. % SrO; and greater than or equal to 0 mol. % and less than or equal to 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %.

The articles formed from the glass compositions described herein may be any suitable shape or thickness, which may vary depending on the particular application for use of the glass composition. Glass sheet embodiments may have a thickness greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, or even less than or equal to 2 mm. In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

In embodiments, the glass compositions and resultant glass articles may have a relatively high refractive index (i.e., greater than or equal 1.97). The refractive index of a glass is a measure of how much light slows down and bends as it passes through the glass, compared to its speed and direction in a vacuum. A relatively high refractive index means that light slows down and bends more significantly as it enters and passes through the glass. As disclosed herein, high refractive indices may be desirable in applications such as AR where efficient bending of light is important. In embodiments, the glass compositions and the resultant glass articles may have a refractive index greater than or equal to 1.97. In embodiments, the glass compositions and resultant glass articles may have an ultra-high refractive index (i.e., greater than or equal to 2.05). In embodiments, the glass composition and the resultant glass article may have a refractive index greater than or equal to 1.97, greater than or equal to 1.98, greater than or equal to 2.00, greater than or equal to 2.03, greater than or equal to 2.05, greater than or equal to 2.07 or even greater than or equal to 2.10.

In embodiments, the glass composition and the resultant glass article may have a density less than or equal to 4.80 g/cm³. In embodiments, the glass composition and the resultant glass article may have a density less than or equal to 4.70 g/cm³. The density of glass is a measure of glass contained in a given volume. A relatively high density means that more mass is packed into a small volume, whereas a low density glass will have less mass in the same volume. As disclosed herein, low density glasses may be desirable in applications such as AR where comfort and weight may influence user adoption. In embodiments, the glass composition and the resultant glass article may have a density greater than or equal to 3.75 g/cm³, greater than or equal to 3.80 g/cm³, greater than or equal to 3.85 g/cm³, greater than or equal to 3.90 g/cm³, or even greater than or equal to 3.95 g/cm³. In embodiments, the glass composition and the resultant glass article may have a density less than or equal to 4.80 g/cm³, less than or equal to 4.70 g/cm³, less than or equal to 4.60 g/cm³, less than or equal to 4.50 g/cm³, less than or equal to 4.40 g/cm³, less than or equal to 4.30 g/cm³, or even less than or equal to 4.20 g/cm³. In embodiments, the glass composition and the resultant glass article may have a density greater than or equal to 3.75 g/cm³ and less than or equal to 4.80 g/cm³, greater than or equal to 3.75 g/cm³ and less than or equal to 4.70 g/cm³, greater than or equal to 3.75 g/cm³ and less than or equal to 4.60 g/cm³, greater than or equal to 3.75 g/cm³ and less than or equal to 4.50 g/cm³, greater than or equal to 3.75 g/cm³ and less than or equal to 4.40 g/cm³, greater than or equal to 3.75 g/cm³ and less than or equal to 4.30 g/cm³, greater than or equal to 3.75 g/cm³ and less than or equal to 4.20 g/cm³, greater than or equal to 3.80 g/cm³ and less than or equal to 4.80 g/cm³, greater than or equal to 3.80 g/cm³ and less than or equal to 4.70 g/cm³, greater than or equal to 3.80 g/cm³ and less than or equal to 4.60 g/cm³, greater than or equal to 3.80 g/cm³ and less than or equal to 4.50 g/cm³, greater than or equal to 3.80 g/cm³ and less than or equal to 4.40 g/cm³, greater than or equal to 3.80 g/cm³ and less than or equal to 4.30 g/cm³, greater than or equal to 3.80 g/cm³ and less than or equal to 4.20 g/cm³, greater than or equal to 3.85 g/cm³ and less than or equal to 4.80 g/cm³, greater than or equal to 3.85 g/cm³ and less than or equal to 4.70 g/cm³, greater than or equal to 3.85 g/cm³ and less than or equal to 4.60 g/cm³, greater than or equal to 3.85 g/cm³ and less than or equal to 4.50 g/cm³, greater than or equal to 3.85 g/cm³ and less than or equal to 4.40 g/cm³, greater than or equal to 3.85 g/cm³ and less than or equal to 4.30 g/cm³, greater than or equal to 3.85 g/cm³ and less than or equal to 4.20 g/cm³, greater than or equal to 3.90 g/cm³ and less than or equal to 4.80 g/cm³, greater than or equal to 3.90 g/cm³ and less than or equal to 4.70 g/cm³, greater than or equal to 3.90 g/cm³ and less than or equal to 4.60 g/cm³, greater than or equal to 3.90 g/cm³ and less than or equal to 4.50 g/cm³, greater than or equal to 3.90 g/cm³ and less than or equal to 4.40 g/cm³, greater than or equal to 3.90 g/cm³ and less than or equal to 4.30 g/cm³, greater than or equal to 3.90 g/cm³ and less than or equal to 4.20 g/cm³, greater than or equal to 3.95 g/cm³ and less than or equal to 4.80 g/cm³, greater than or equal to 3.95 g/cm³ and less than or equal to 4.70 g/cm³, greater than or equal to 3.95 g/cm³ and less than or equal to 4.60 g/cm³, greater than or equal to 3.95 g/cm³ and less than or equal to 4.50 g/cm³, greater than or equal to 3.95 g/cm³ and less than or equal to 4.40 g/cm³, greater than or equal to 3.95 g/cm³ and less than or equal to 4.30 g/cm³, or even greater than or equal to 3.95 g/cm³ and less than or equal to 4.20 g/cm³, or any and all sub-ranges formed from any of these endpoints.

It was unexpectedly found that the glass compositions having an ultra-high refractive index (i.e., greater than or equal to 2.05), according to the embodiments disclosed herein, still have densities that fall into the above ranges for density. Conventional ultra-high refractive index glasses may have relatively higher densities, such as densities greater than 4.8 g/cm³. The combination of ultra-high refractive index and lower-density properties in a single glass composition may be desirable in applications such as lightweight optical devices, high-performance lenses, and other technologies where both optical performance and light weight considerations are desired.

As discussed hereinabove, the glass compositions and the resultant glass articles described herein may have a relatively high refractive index and a relatively low density such that the glass compositions and the resultant glass articles are suitable for AR headsets. Additionally, the glass compositions and the resultant glass articles described herein may have high rigidity. These properties are reflected in the relatively high Young's modulus (i.e., greater than or equal to 100 GPa), shear modulus (i.e., greater than or equal to 40 GPa), and Poisson's Ratio (i.e., greater than or equal to 0.28). Without being bound by any theory, it is believed that the glass compositions' relatively high amount of index modifiers (i.e., Nb₂O₃, Ta₂O₅, Y₂O₃, ZrO₂, and La₂O₃ to TiO₂ in an amount of at least 47 mol. %) result in high rigidity, as these components correlate with higher moduli. Additionally, glass compositions containing B₂O₃ and P₂O₅ may be more likely to be brittle and exhibit low fracture toughness. As the glass compositions herein contain little to no amounts of B₂O₃ and may be free or substantially-free of P₂O₅, the glass compositions herein have higher fracture toughness.

In embodiments, the glass composition and the resultant glass article may have a Young's modulus greater than or equal to 90 GPa, greater than or equal to 95 GPa, greater than or equal to 100 GPa, greater than or equal to 105 GPa, or even greater than or equal to 110 GPa. In embodiments, the glass composition and the resultant glass article may have a Young's modulus less than or equal to 150 GPa, less than or equal to 140 GPa, or even less than or equal to 130 GPa. In embodiments, the glass composition and the resultant glass article may have a Young's modulus greater than or equal to 90 GPa and less than or equal to 150 GPa, greater than or equal to 90 GPa and less than or equal to 140 GPa, greater than or equal to 90 GPa and less than or equal to 130 GPa, greater than or equal to 95 GPa and less than or equal to 150 GPa, greater than or equal to 95 GPa and less than or equal to 140 GPa, greater than or equal to 95 GPa and less than or equal to 130 GPa, greater than or equal to 100 GPa and less than or equal to 150 GPa, greater than or equal to 100 GPa and less than or equal to 140 GPa, greater than or equal to 100 GPa and less than or equal to 130 GPa, greater than or equal to 105 GPa and less than or equal to 150 GPa, greater than or equal to 105 GPa and less than or equal to 140 GPa, greater than or equal to 105 GPa and less than or equal to 130 GPa, greater than or equal to 110 GPa and less than or equal to 150 GPa, greater than or equal to 110 GPa and less than or equal to 140 GPa, or even greater than or equal to 110 GPa and less than or equal to 130 GPa, or any and all sub-ranges formed from any of these endpoints.

In embodiments, the glass composition and the resultant glass article may have a shear modulus greater than or equal to 30, greater than or equal to 35 GPa, or even greater than or equal to 40 GPa. In embodiments, the glass composition and the resultant glass article may have a shear modulus less than or equal to 60 GPa, less than or equal to 55 GPa, or even less than or equal to 50 GPa. In embodiments, the glass composition and the resultant glass article may have a shear modulus greater than or equal to 30 GPa and less than or equal to 60 GPa, greater than or equal to 30 GPa and less than or equal to 55 GPa, greater than or equal to 30 GPa and less than or equal to 50 GPa, greater than or equal to 35 GPa and less than or equal to 60 GPa, greater than or equal to 35 GPa and less than or equal to 55 GPa, greater than or equal to 35 GPa and less than or equal to 50 GPa, greater than or equal to 40 GPa and less than or equal to 60 GPa, greater than or equal to 40 GPa and less than or equal to 55 GPa, or even greater than or equal to 40 GPa and less than or equal to 50 GPa, or any and all sub-ranges formed from any of these endpoints.

In embodiments, the glass compositions and the resultant glass articles described herein may have a relatively high Poisson's ratio, which increases the fracture energy such that the glass compositions are more resistant to damage. In embodiments, the glass composition and the resultant glass article may have a Poisson's ratio greater than or equal to 0.26, greater than or equal to 0.27, or even greater than or equal to 0.28. In embodiments, the glass composition and the resultant glass article may have a Poisson's ratio less than or equal to 0.31, less than or equal to 0.30, or even less than or equal to 0.29. In embodiments, the glass composition and the resultant glass article may have a Poisson's ratio greater than or equal to 0.26 and less than or equal to 0.31, greater than or equal to 0.26 and less than or equal to 0.30, greater than or equal to 0.26 and less than or equal to 0.29, greater than or equal to 0.27 and less than or equal to 0.31, greater than or equal to 0.26 and less than or equal to 0.30, greater than or equal to 0.26 and less than or equal to 0.29, greater than or equal to 0.27 and less than or equal to 0.31, greater than or equal to 0.27 and less than or equal to 0.30, or even greater than or equal to 0.27 and less than or equal to 0.29, or any and all sub-ranges formed from any of these endpoints.

In embodiments, a glass article may comprise: a glass composition comprising: greater than or equal to 35 mol. % and less than or equal to 62 mol. % TiO₂; greater than or equal to 6 mol. % and less than or equal to 30 mol. % SiO₂; greater than or equal to 1 mol. % and less than or equal to 30 mol. % BaO; and greater than or equal to 1 mol. % and less than or equal to 25 mol. % SrO; and greater than or equal to 0 mol. % and less than or equal to 10 mol. % B₂O₃, wherein: a sum of TiO₂, Nb₂O₃, Ta₂O₅, Y₂O₃, ZrO₂, and La₂O₃ is greater than or equal to 47 mol. %, RO is greater than or equal to 20 mol. % and less than or equal to 50 mol. %, wherein RO is the sum of BaO, SrO, and CaO; and a total sum of concentrations of oxide components in the glass composition is equal to 100 mol. %, wherein the glass article comprises: an ultra-high refractive index (n_{d}) at 589.3 nm greater than or equal to 2.05, and a density less than 4.8 g/cm³.

In embodiments, the process for making a glass article includes heat treating the glass composition as described herein at one or more preselected temperatures for one or more preselected times to melt the glass composition and cooling the glass composition. In embodiments, the heat treatment for making a glass article may include (i) heating a batch of the glass composition at a rate of 1-100° C./min to glass melting temperature; (ii) maintaining the batch of the glass composition at the glass melting temperature for a time greater than or equal to 4 hours and less than or equal to 100 hours to produce a glass precursor article; and (iii) cooling the formed glass precursor article to room temperature to form a glass article. In embodiments, the glass melting temperature may be greater than or equal to 1500° C. and less than or equal to 1700° C.

The glass compositions and resultant glass articles described herein may be used for a variety of applications including, for example, for AR headsets. Other applications may use the glass compositions and resultant glass articles described herein, including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (i.e., smartphones, tablet computers, watches, personal computers, ultrabooks, televisions, and cameras), an architectural glass, and/or an automotive glass may comprise a glass article as described herein.

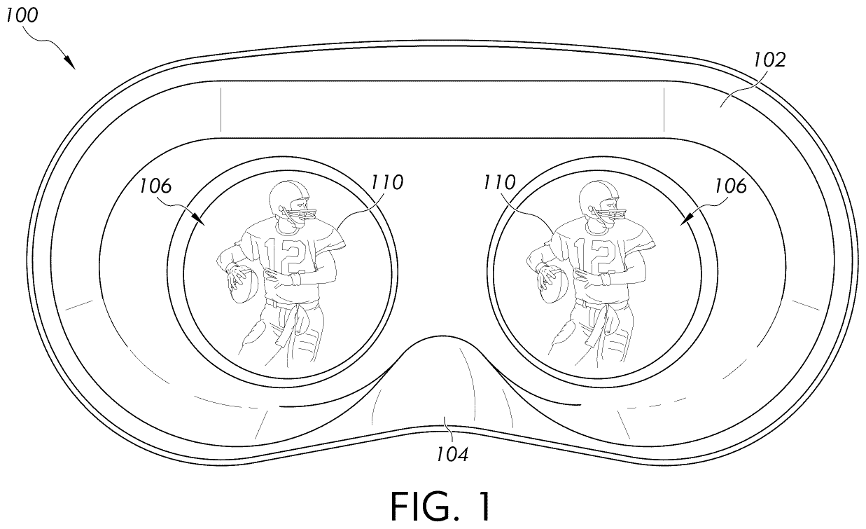

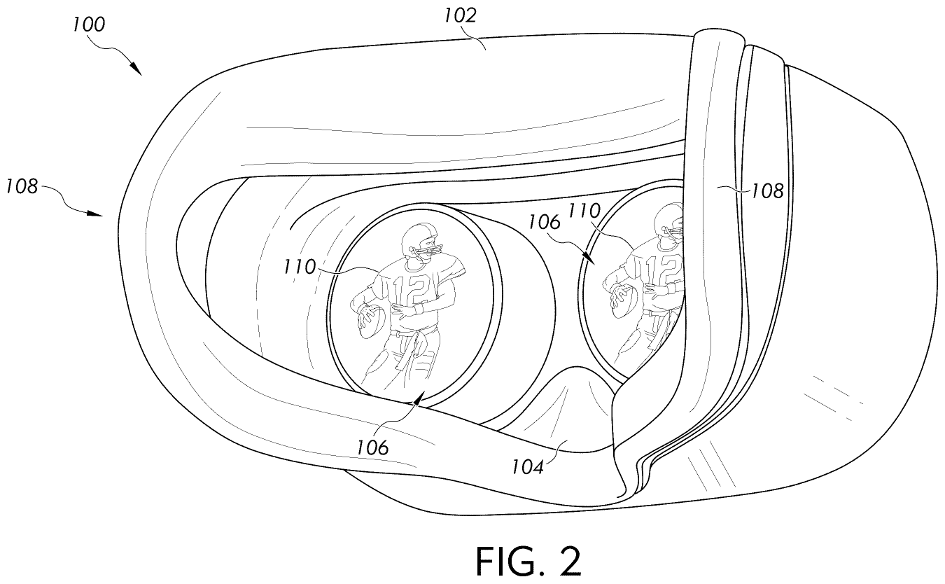

An exemplary electronic device incorporating any of the glass articles disclosed herein is shown in FIGS. 1 and 2. Specifically, FIGS. 1 and 2 show a consumer electronic device 100 including a housing 102 conformed to be placed over an individual's eyes and having a nose cutout 104, lenses 106, and side shields 108. Electrical components (not shown) that are at least partially inside or entirely within the housing and including at least a controller, a memory, and displays at or adjacent to the lenses 106. An individual's eyes align with the lenses 106 and displays 110. In embodiments, the lenses 106 may include any of the glass articles disclosed herein.

### EXAMPLES

In order that various embodiments be more readily understood, reference is made to the following examples, which are intended to illustrate various embodiments of the glass compositions described herein.

Tables 1 and 2 show example glass compositions and comparative glass compositions (in terms of mol. %) and the respective properties of the glass compositions. Glass articles are formed having the examples glass compositions E1-E82 and comparative glass compositions C1-C8. The mechanical properties (i.e., Young's modulus, shear modulus, and Poisson's ratio) of Examples E1-E79 and comparative glass compositions C1-C8 were measured using Brillouin scattering (BRS).

BRS is measured using a tandem interferometer at 90 degrees and 532 nm excitation. The Brilluoin frequency shift lies in GHz frequency range and is related to material parameters and angle between excitation and scattering beam as:

$$Δ f = ( 2 n sin φ / 2 ) V / {λ}_{o} ,$$

where n is refractive index, V is speed of sound, φ is angle between excitation and scattering beams, λₒ is wavelength of light. Both longitudinal and transverse peaks are typically observed in solid materials, which allows for both longitudinal and transverse speeds of sound. When the angle is 180 degrees, one cannot observe transverse peaks, but the signal is very large and may be used in the test for better accuracy. Speed of sound is related to mechanical properties and density of the material. Using Brilluoin spectroscopy and knowing density, the speed of sound may be obtained and all major mechanical properties of the material such as Young's modulus, shear modulus, and Poisson ratio may be derived therefrom.

TABLE 1

| Example | E1 | E2 | E3 | E4 | E5 | E6 | E7 |
|---|---|---|---|---|---|---|---|
| TiO₂ | 50.00 | 50.00 | 50.00 | 50.00 | 50.00 | 48.64 | 48.58 |
| SiO₂ | 20.00 | 20.00 | 20.00 | 22.54 | 22.58 | 20.00 | 20.00 |
| BaO | 18.91 | 14.23 | 14.58 | 12.45 | 18.58 | 10.14 | 10.14 |
| SrO | 5.00 | 10.10 | 5.00 | 14.97 | 8.99 | 10.00 | 10.00 |
| CaO | 6.09 | 5.68 | 10.42 | — | — | 9.86 | 9.86 |
| Y₂O₃ | — | — | — | — | — | 1.36 | — |
| ZrO₂ | — | — | — | — | — | — | 1.42 |
| La₂O₃ | — | — | — | — | — | — | — |
| Ta₂O₅ | — | — | — | — | — | — | — |
| Nb₂O₃, | — | — | — | — | — | — | — |
| Sum | 100.00 | 100.00 | 100.00 | 100.00 | 100.00 | 100.00 | 100.00 |
| RO | 30.00 | 30.01 | 30.00 | 27.42 | 27.57 | 30.00 | 30.00 |
| Sum of TiO₂, | 50.00 | 50.00 | 50.00 | 50.00 | 50.00 | 50.00 | 50.00 |
| Nb₂O₃, Ta₂O₅, | | | | | | | |
| Y₂O₃, ZrO₂, and La₂O₃ | | | | | | | |
| Refractive Index | 2.012 | 2.011 | 2.020 | 2.007 | 2.003 | 2.010 | 2.010 |
| Density (g/cm³) | 4.125 | 4.099 | 3.996 | 4.084 | 4.156 | 3.999 | 3.986 |
| Young's Modulus (GPa) | 112.1 | 115.2 | 116.5 | 114.2 | 113.9 | 118.4 | 118.0 |
| Shear Modulus (GPa) | 43.5 | 44.7 | 45.2 | 44.4 | 44.3 | 45.9 | 45.8 |
| Poisson's Ratio | 0.289 | 0.288 | 0.289 | 0.286 | 0.287 | 0.291 | 0.289 |
| Example | E8 | E9 | E10 | E11 | E12 | E13 | E14 |
| TiO₂ | 45.00 | 46.53 | 46.45 | 47.74 | 46.49 | 46.51 | 45.00 |
| SiO₂ | 20.00 | 20.02 | 20.00 | 20.00 | 20.00 | 20.00 | 20.00 |
| BaO | 10.14 | 18.93 | 10.14 | 10.14 | 10.14 | 10.14 | 10.14 |
| SrO | 10.00 | 6.01 | 10.00 | 10.00 | 10.00 | 10.00 | 10.00 |
| CaO | 9.86 | 5.00 | 9.86 | 9.86 | 9.86 | 9.86 | 9.86 |
| Y₂O₃ | — | — | — | — | — | — | — |
| ZrO₂ | 5.00 | — | 3.55 | — | — | — | — |
| La₂O₃ | — | 2.30 | — | — | 2.28 | 1.30 | 1.49 |
| Ta₂O₅ | — | 1.21 | — | 2.26 | 1.23 | 2.19 | 3.51 |
| Nb₂O₃, | — | — | — | — | — | — | — |
| Sum | 100.00 | 100.00 | 100.00 | 100.00 | 100.00 | 100.00 | 100.00 |
| RO | 30.00 | 29.94 | 30.00 | 30.00 | 30.00 | 30.00 | 30.00 |
| Sum of TiO₂, | 50.00 | 50.04 | 50.00 | 50.00 | 50.00 | 50.00 | 50.00 |
| Nb₂O₃, Ta₂O₅, | | | | | | | |
| Y₂O₃, ZrO₂, and La₂O₃ | | | | | | | |
| Refractive Index | 2.005 | 2.006 | 2.002 | 2.014 | 2.001 | 2.010 | 2.016 |
| Density (g/cm³) | 4.065 | 4.388 | 4.039 | 4.198 | 4.240 | 4.301 | 4.413 |
| Young's Modulus (GPa) | 118.8 | 122.6 | 118.5 | 123.2 | 118.5 | 119.7 | 122.6 |
| Shear Modulus (GPa) | 46.1 | 47.5 | 46.0 | 47.8 | 45.9 | 46.4 | 47.5 |
| Poisson's Ratio | 0.289 | 0.289 | 0.287 | 0.289 | 0.292 | 0.290 | 0.289 |
| Example | E15 | E16 | E17 | E18 | E19 | E20 | E21 |
| TiO₂ | 50.00 | 50.00 | 50.00 | 50.00 | 50.00 | 50.00 | 46.50 |
| SiO₂ | 20.00 | 20.71 | 21.22 | 21.74 | 22.42 | 20.00 | 20.00 |
| BaO | 14.58 | 15.75 | 16.61 | 17.45 | 18.58 | 14.58 | 14.58 |
| SrO | 5.00 | 6.16 | 7.01 | 7.86 | 9.00 | 5.00 | 5.00 |
| CaO | 10.42 | 7.38 | 5.16 | 2.95 | — | 10.42 | 10.42 |
| Y₂O₃ | — | — | — | — | — | — | — |
| ZrO₂ | — | — | — | — | — | — | — |
| La₂O₃ | — | — | — | — | — | — | — |
| Ta₂O₅ | — | — | — | — | — | — | — |
| Nb₂O₃, | — | — | — | — | — | — | 3.50 |
| Sum | 100.00 | 100.00 | 100.00 | 100.00 | 100.00 | 100.00 | 100.00 |
| RO | 30.00 | 29.29 | 28.78 | 28.26 | 27.58 | 30.00 | 30.00 |
| Sum of TiO₂, | 50.00 | 50.00 | 50.00 | 50.00 | 50.00 | 50.00 | 50.00 |
| Nb₂O₃, Ta₂O₅, | | | | | | | |
| Y₂O₃, ZrO₂, and La₂O₃ | | | | | | | |
| Refractive Index | 2.021 | 2.009 | 2.011 | 1.998 | 2.001 | 2.020 | 2.030 |
| Density (g/cm³) | 4.014 | 4.077 | 4.09 | 4.137 | 4.15 | 4.008 | 4.072 |
| Young's Modulus (GPa) | 117.0 | 114.7 | 111.7 | 111.5 | 111.4 | 114.6 | 116.3 |
| Shear Modulus (GPa) | 45.4 | 44.6 | 43.4 | 43.3 | 43.3 | 44.5 | 45.2 |
| Poisson's Ratio | 0.288 | 0.287 | 0.288 | 0.287 | 0.286 | 0.289 | 0.286 |
| Example | E22 | E23 | E24 | E25 | E26 | E27 | E28 |
| TiO₂ | 43.54 | 45.00 | 42.60 | 40.60 | 40.62 | 45.00 | 42.63 |
| SiO₂ | 20.00 | 20.00 | 20.00 | 20.01 | 17.54 | 20.00 | 20.00 |
| BaO | 14.58 | 10.14 | 10.14 | 10.14 | 10.14 | 10.14 | 10.14 |
| SrO | 5.00 | 10.00 | 10.00 | 10.00 | 10.00 | 10.00 | 10.00 |
| CaO | 10.42 | 9.86 | 9.86 | 9.86 | 9.86 | 9.86 | 9.86 |
| Y₂O₃ | — | — | — | — | — | 2.42 | 2.42 |
| ZrO₂ | — | 5.00 | 5.00 | 5.00 | 5.00 | 2.58 | 2.58 |
| La₂O₃ | — | — | — | — | — | — | — |
| Ta₂O₅ | — | — | — | — | — | — | — |
| Nb₂O₃, | 6.46 | — | 2.40 | 4.39 | 6.84 | — | 2.37 |
| Sum | 100.00 | 100.00 | 100.00 | 100.00 | 100.00 | 100.00 | 100.00 |
| RO | 30.00 | 30.00 | 30.00 | 30.00 | 30.00 | 30.00 | 30.00 |
| Sum of TiO₂, | 50.00 | 50.00 | 50.00 | 49.99 | 52.46 | 50.00 | 50.00 |
| Nb₂O₃, Ta₂O₅, | | | | | | | |
| Y₂O₃, ZrO₂, and La₂O₃ | | | | | | | |
| Refractive Index | 2.050 | 2.008 | 2.014 | 2.022 | 2.060 | 2.000 | 2.000 |
| Density (g/cm³) | 4.114 | 4.121 | 4.092 | 4.146 | 4.292 | 4.094 | 4.128 |
| Young's Modulus (GPa) | 119.4 | 123.5 | 120.2 | 120.5 | 124.6 | 121.0 | 120.4 |
| Shear Modulus (GPa) | 46.4 | 48.0 | 46.7 | 46.8 | 48.3 | 47.0 | 46.7 |
| Poisson's Ratio | 0.287 | 0.287 | 0.287 | 0.286 | 0.289 | 0.287 | 0.288 |
| Example | E29 | E30 | E31 | E32 | E33 | E34 | E35 |
| TiO₂ | 40.64 | 40.61 | 45.00 | 40.42 | 40.51 | 45.00 | 40.56 |
| SiO₂ | 20.00 | 17.60 | 15.45 | 20.00 | 17.49 | 15.60 | 20.00 |
| BaO | 10.14 | 10.14 | 19.00 | 19.00 | 19.00 | 10.14 | 10.14 |
| SrO | 10.00 | 10.00 | 5.00 | 5.00 | 5.00 | 10.00 | 10.00 |
| CaO | 9.86 | 9.86 | 6.00 | 6.00 | 6.00 | 9.86 | 9.86 |
| Y₂O₃ | 2.42 | 2.42 | — | — | — | 1.10 | 1.11 |
| ZrO₂ | 2.58 | 2.58 | — | — | — | 5.00 | 5.00 |
| La₂O₃ | — | — | — | — | — | 1.10 | 1.11 |
| Ta₂O₅ | — | — | 5.00 | 5.00 | 5.00 | 1.10 | 1.11 |
| Nb₂O₃, | 4.36 | 6.79 | 4.55 | 4.58 | 7.00 | 1.10 | 1.11 |
| Sum | 100.00 | 100.00 | 100.00 | 100.00 | 100.00 | 100.00 | 100.00 |
| RO | 30.00 | 30.00 | 30.00 | 30.00 | 30.00 | 30.00 | 30.00 |
| Sum of TiO₂, | 50.00 | 52.40 | 54.55 | 50.00 | 52.51 | 54.40 | 50.00 |
| Nb₂O₃, Ta₂O₅, | | | | | | | |
| Y₂O₃, ZrO₂, and La₂O₃ | | | | | | | |
| Refractive Index | 2.020 | 2.050 | 2.070 | 2.050 | 2.080 | 2.040 | 2.010 |
| Density (g/cm³) | 4.145 | 4.257 | 4.755 | 4.646 | 4.743 | 4.431 | 4.299 |
| Young's Modulus (GPa) | 122.4 | 123.1 | 123.2 | 118.8 | 97.3 | 124.9 | 120.4 |
| Shear Modulus (GPa) | 47.6 | 47.8 | 47.7 | 46.2 | 38.1 | 48.4 | 46.7 |
| Poisson's Ratio | 0.286 | 0.288 | 0.293 | 0.286 | 0.279 | 0.291 | 0.288 |
| Example | E36 | E37 | E38 | E39 | E40 | E41 | E42 |
| TiO₂ | 45.00 | 42.50 | 40.59 | 38.36 | 48.58 | 48.58 | 46.18 |
| SiO₂ | 13.36 | 15.62 | 17.53 | 20.00 | 20.00 | 17.71 | 20.00 |
| BaO | 10.14 | 10.14 | 10.14 | 10.14 | 10.14 | 10.14 | 10.14 |
| SrO | 10.00 | 10.00 | 10.00 | 10.00 | 10.00 | 10.00 | 10.00 |
| CaO | 9.86 | 9.86 | 9.86 | 9.86 | 9.86 | 9.86 | 9.86 |
| Y₂O₃ | 1.66 | 1.72 | 1.72 | 1.66 | — | — | — |
| ZrO₂ | 5.00 | 5.00 | 5.00 | 5.00 | 1.42 | 1.42 | 1.42 |
| La₂O₃ | 1.66 | 1.72 | 1.72 | 1.66 | — | — | — |
| Ta₂O₅ | 1.66 | 1.72 | 1.72 | 1.66 | — | — | — |
| Nb₂O₃, | 1.66 | 1.72 | 1.72 | 1.66 | — | 2.29 | 2.40 |
| Sum | 100.00 | 100.00 | 100.00 | 100.00 | 100.00 | 100.00 | 100.00 |
| RO | 30.00 | 30.00 | 30.00 | 30.00 | 30.00 | 30.00 | 30.00 |
| Sum of TiO₂, | 56.64 | 54.38 | 52.47 | 50.00 | 50.00 | 52.29 | 50.00 |
| Nb₂O₃, Ta₂O₅, | | | | | | | |
| Y₂O₃, ZrO₂, and La₂O₃ | | | | | | | |
| Refractive Index | 2.060 | 2.040 | 2.020 | 2.010 | 2.027 | 2.048 | 2.029 |
| Density (g/cm³) | 4.541 | 4.462 | 4.464 | 4.421 | 4.026 | 4.057 | 4.041 |
| Young's Modulus (GPa) | 125.6 | 122.1 | 123.8 | 121.7 | 117.7 | 120.7 | 118.0 |
| Shear Modulus (GPa) | 48.5 | 47.3 | 48.0 | 47.1 | 45.7 | 46.8 | 45.8 |
| Poisson's Ratio | 0.294 | 0.291 | 0.291 | 0.291 | 0.288 | 0.289 | 0.288 |
| Example | E43 | E44 | E45 | E46 | E47 | E48 | E49 |
| TiO₂ | 46.19 | 44.19 | 44.14 | 41.98 | 41.33 | 38.58 | 50.00 |
| SiO₂ | 17.76 | 20.00 | 17.64 | 20.00 | 17.25 | 20.00 | 20.00 |
| BaO | 10.14 | 10.14 | 10.14 | 10.14 | 10.14 | 10.14 | 14.58 |
| SrO | 10.00 | 10.00 | 10.00 | 10.00 | 10.00 | 10.00 | 5.00 |
| CaO | 9.86 | 9.86 | 9.86 | 9.86 | 9.86 | 9.86 | 10.42 |
| Y₂O₃ | — | — | — | — | — | — | — |
| ZrO₂ | 1.42 | 1.42 | 1.42 | 1.42 | 1.42 | 1.42 | — |
| La₂O₃ | — | — | — | — | — | — | — |
| Ta₂O₅ | — | — | — | — | — | — | — |
| Nb₂O₃, | 4.63 | 4.39 | 6.80 | 6.60 | 10.00 | 10.00 | — |
| Sum | 100.00 | 100.00 | 100.00 | 100.00 | 100.00 | 100.00 | 100.00 |
| RO | 30.00 | 30.00 | 30.00 | 30.00 | 30.00 | 30.00 | 30.00 |
| Sum of TiO₂, | 52.24 | 50.00 | 52.36 | 50.00 | 52.75 | 50.00 | 50.00 |
| Nb₂O₃, Ta₂O₅, | | | | | | | |
| Y₂O₃, ZrO₂, and La₂O₃ | | | | | | | |
| Refractive Index | 2.034 | 2.055 | 2.061 | 2.041 | 2.078 | 2.055 | 2.018 |
| Density (g/cm³) | 4.079 | 4.100 | 4.183 | 4.132 | 4.225 | 4.197 | 4.088 |
| Young's Modulus (GPa) | 120.2 | 119.2 | 121.9 | 119.8 | 119.9 | 118.8 | 118.9 |
| Shear Modulus (GPa) | 46.7 | 46.3 | 47.4 | 46.5 | 46.5 | 46.2 | 46.1 |
| Poisson's Ratio | 0.286 | 0.289 | 0.287 | 0.287 | 0.288 | 0.285 | 0.288 |
| Example | E50 | E51 | E52 | E53 | E54 | E55 | E56 |
| TiO₂ | 46.60 | 46.40 | 43.69 | 43.40 | 40.35 | 39.89 | 45.00 |
| SiO₂ | 20.00 | 20.00 | 20.00 | 20.00 | 20.00 | 20.00 | 13.42 |
| BaO | 14.58 | 12.89 | 14.58 | 11.50 | 14.58 | 12.79 | 10.14 |
| SrO | 5.00 | 4.28 | 5.00 | 3.68 | 5.00 | 4.23 | 10.00 |
| CaO | 10.42 | 12.82 | 10.42 | 14.82 | 10.42 | 12.98 | 9.86 |
| Y₂O₃ | 0.68 | 0.72 | 1.26 | 1.32 | 1.93 | 2.02 | — |
| ZrO₂ | — | — | — | — | — | — | 5.00 |
| La₂O₃ | 0.68 | 0.72 | 1.26 | 1.32 | 1.93 | 2.02 | — |
| Ta₂O₅ | 0.68 | 0.72 | 1.26 | 1.32 | 1.93 | 2.02 | — |
| Nb₂O₃, | 1.36 | 1.45 | 2.53 | 2.64 | 3.86 | 4.05 | 6.58 |
| Sum | 100.00 | 100.00 | 100.00 | 100.00 | 100.00 | 100.00 | 100.00 |
| RO | 30.00 | 29.99 | 30.00 | 30.00 | 30.00 | 30.00 | 30.00 |
| Sum of TiO₂, | 50.00 | 50.01 | 50.00 | 50.00 | 50.00 | 50.00 | 56.58 |
| Nb₂O₃, Ta₂O₅, | | | | | | | |
| Y₂O₃, ZrO₂, and La₂O₃ | | | | | | | |
| Refractive Index | 2.014 | 2.025 | 2.024 | 2.013 | 2.020 | 2.014 | — |
| Density (g/cm³) | 4.195 | 4.104 | 4.292 | 4.222 | 4.465 | 4.467 | 4.288 |
| Young's Modulus (GPa) | 118.7 | 120.0 | 119.6 | 121.2 | 120.8 | 123.0 | — |
| Shear Modulus (GPa) | 46.1 | 46.6 | 46.4 | 47.0 | 46.9 | 47.7 | — |
| Poisson's Ratio | 0.288 | 0.288 | 0.289 | 0.289 | 0.289 | 0.290 | — |
| Example | E57 | E58 | E59 | E60 | E61 | E62 | E63 |
| TiO₂ | 45.00 | 43.69 | 45.00 | 43.75 | 42.66 | 45.00 | 43.69 |
| SiO₂ | 12.13 | 13.42 | 11.10 | 12.19 | 13.42 | 13.42 | 13.42 |
| BaO | 10.14 | 10.14 | 10.14 | 10.14 | 10.14 | 10.14 | 10.14 |
| SrO | 10.00 | 10.00 | 10.00 | 10.00 | 10.00 | 10.00 | 10.00 |
| CaO | 9.86 | 9.86 | 9.86 | 9.86 | 9.86 | 9.86 | 9.86 |
| Y₂O₃ | — | — | — | — | — | — | — |
| ZrO₂ | 5.00 | 5.00 | 5.00 | 5.00 | 5.00 | 3.63 | 5.00 |
| La₂O₃ | 1.29 | 1.31 | 2.32 | 2.48 | 2.34 | 0.68 | 0.65 |
| Ta₂O₅ | — | — | — | — | — | — | — |
| Nb₂O₃, | 6.58 | 6.58 | 6.58 | 6.58 | 6.58 | 7.27 | 7.24 |
| Sum | 100.00 | 100.00 | 100.00 | 100.00 | 100.00 | 100.00 | 100.00 |
| RO | 30.00 | 30.00 | 30.00 | 30.00 | 30.00 | 30.00 | 30.00 |
| Sum of TiO₂, | 57.87 | 56.58 | 58.90 | 57.81 | 56.58 | 56.58 | 56.58 |
| Nb₂O₃, Ta₂O₅, | | | | | | | |
| Y₂O₃, ZrO₂, and La₂O₃ | | | | | | | |
| Refractive Index | — | — | — | — | — | — | — |
| Density (g/cm³) | 4.380 | 4.354 | 4.502 | 4.434 | 4.417 | 4.305 | 4.399 |
| Young's Modulus (GPa) | — | — | — | — | — | — | — |
| Shear Modulus (GPa) | — | — | — | — | — | — | — |
| Poisson's Ratio | — | — | — | — | — | — | — |
| Example | E64 | E65 | E66 | E67 | E68 | E69 | E70 |
| TiO₂ | 42.66 | 42.77 | 50.00 | 50.00 | 46.64 | 45.04 | 45.04 |
| SiO₂ | 13.42 | 13.42 | 20.00 | 20.38 | 20.00 | 20.02 | 20.02 |
| BaO | 10.14 | 10.14 | 10.14 | 13.47 | 10.14 | 18.93 | 18.93 |
| SrO | 10.00 | 10.00 | 10.00 | 16.15 | 10.00 | 5.00 | 5.00 |
| CaO | 9.86 | 9.86 | 9.86 | — | 9.86 | 6.01 | 6.01 |
| Y₂O₃ | — | — | — | — | — | 5.00 | — |
| ZrO₂ | 5.00 | 3.66 | — | — | — | — | — |
| La₂O₃ | 1.17 | 1.78 | — | — | — | — | 2.58 |
| Ta₂O₅ | — | — | — | — | 3.36 | — | 2.42 |
| Nb₂O₃, | 7.75 | 8.37 | — | — | — | — | — |
| Sum | 100.00 | 100.00 | 100.00 | 100.00 | 100.00 | 100.00 | 100.00 |
| RO | 30.00 | 30.00 | 30.00 | 29.62 | 30.00 | 29.94 | 29.94 |
| Sum of TiO₂, | 56.58 | 56.58 | 50.00 | 50.00 | 50.00 | 50.04 | 50.04 |
| Nb₂O₃, Ta₂O₅, | | | | | | | |
| Y₂O₃, ZrO₂, and La₂O₃ | | | | | | | |
| Refractive Index | — | — | 2.021 | 2.003 | 2.010 | 1.977 | 1.995 |
| Density (g/cm³) | 4.465 | 4.404 | 3.958 | 4.155 | 4.326 | 4.286 | 4.606 |
| Young's Modulus (GPa) | — | — | 119.0 | — | 119.7 | 110.4 | 110.2 |
| Shear Modulus (GPa) | — | — | 46.3 | — | 46.5 | 42.7 | 42.7 |
| Poisson's Ratio | — | — | — | — | — | — | — |
| Example | E71 | E72 | E73 | E74 | E75 | E76 | E77 |
| TiO₂ | 45.04 | 42.29 | 46.74 | 50.00 | 48.85 | 47.84 | 45.00 |
| SiO₂ | 20.02 | 17.56 | 13.49 | 15.64 | 15.35 | 15.68 | 17.70 |
| BaO | 18.93 | 14.58 | 14.58 | 16.73 | 17.74 | 18.91 | 10.14 |
| SrO | 5.00 | 5.00 | 5.00 | 5.00 | 5.00 | 5.00 | 10.00 |
| CaO | 6.01 | 10.42 | 10.42 | 6.09 | 6.09 | 6.09 | 9.86 |
| Y₂O₃ | — | — | — | — | — | — | 2.42 |
| ZrO₂ | — | — | — | — | — | — | 2.58 |
| La₂O₃ | — | — | — | — | — | — | — |
| Ta₂O₅ | 5.00 | — | — | — | — | — | — |
| Nb₂O₃, | — | 10.15 | 9.77 | 6.54 | 6.97 | 6.48 | 2.30 |
| Sum | 100.00 | 100.00 | 100.00 | 100.00 | 100.00 | 100.00 | 100.00 |
| RO | 29.94 | 30.00 | 30.00 | 27.82 | 28.83 | 30.00 | 30.00 |
| Sum of TiO₂, | 50.04 | 52.44 | 56.51 | 56.54 | 55.82 | 54.32 | 52.30 |
| Nb₂O₃, Ta₂O₅, | | | | | | | |
| Y₂O₃, ZrO₂, and La₂O₃ | | | | | | | |
| Refractive Index | 2.033 | 2.080 | 2.110 | 2.090 | 2.090 | 2.070 | 2.030 |
| Density (g/cm³) | 4.602 | 4.230 | 4.281 | 4.251 | 4.357 | 4.303 | 4.186 |
| Young's Modulus (GPa) | 119.7 | 119.0 | — | 117.6 | 119.4 | 117.1 | 123.2 |
| Shear Modulus (GPa) | 46.5 | 46.2 | — | 45.6 | 46.2 | 45.4 | 47.8 |
| Poisson's Ratio | 0.286 | 0.288 | — | 0.289 | 0.290 | 0.289 | 0.288 |

| Example | E78 | E79 | E80 | E81 | E82 |
|---|---|---|---|---|---|
| TiO₂ | 45.00 | 42.65 | 38.43 | 37.80 | 35.00 |
| SiO₂ | 15.73 | 17.73 | 20.00 | 17.20 | 20.00 |
| BaO | 10.14 | 10.14 | 10.14 | 10.14 | 10.14 |
| SrO | 10.00 | 10.00 | 10.00 | 10.00 | 10.00 |
| CaO | 9.86 | 9.86 | 9.86 | 9.86 | 9.86 |
| Y₂O₃ | 2.42 | 2.42 | 2.42 | 2.42 | 2.42 |
| ZrO₂ | 2.58 | 2.58 | 2.58 | 2.58 | 2.58 |
| La₂O₃ | — | — | — | — | — |
| Ta₂O₅ | — | — | — | — | — |
| Nb₂O₃, | 4.27 | 4.62 | 6.57 | 10.00 | 10.00 |
| Sum | 100.00 | 100.00 | 100.00 | 100.00 | 100.00 |
| RO | 30.00 | 30.00 | 30.00 | 30.00 | 30.00 |
| Sum of TiO₂, | 54.27 | 52.27 | 50.00 | 52.80 | 50.00 |
| Nb₂O₃, Ta₂O₅, | | | | | |
| Y₂O₃, ZrO₂, and La₂O₃ | | | | | |
| Refractive Index | 2.050 | 2.040 | 2.030 | 2.060 | 2.040 |
| Density (g/cm³) | 4.231 | 4.207 | 4.344 | 4.313 | 4.274 |
| Young's Modulus (GPa) | 123.3 | 122.5 | 125.2 | 123.3 | 120.9 |
| Shear Modulus (GPa) | 47.8 | 47.5 | 48.7 | 47.8 | 47.0 |
| Poisson's Ratio | 0.289 | 0.289 | 0.287 | 0.290 | 0.285 |

TABLE 2

| Example | C1 | C2 | C3 | C4 | C5 | C6 | C7 | C8 |
|---|---|---|---|---|---|---|---|---|
| TiO₂ | 20.00 | 32.80 | 34.90 | 37.07 | 39.80 | 41.70 | 42.52 | 44.72 |
| SiO₂ | 40.00 | 37.20 | 35.10 | 32.93 | 30.20 | 28.30 | 27.48 | 25.28 |
| BaO | — | — | — | — | — | — | 30.00 | 30.00 |
| SrO | 30.00 | 30.00 | 30.00 | 30.00 | 30.00 | 30.00 | — | — |
| CaO | — | — | — | — | — | — | — | — |
| Sum | 100.00 | 100.00 | 100.00 | 100.00 | 100.00 | 100.00 | 100.00 | 100.00 |
| RO | 30.00 | 30.00 | 30.00 | 30.00 | 30.00 | 30.00 | 30.00 | 30.00 |
| Sum of TiO₂, Nb₂O₃, Ta₂O₅, | 20.00 | 32.80 | 34.90 | 37.07 | 39.80 | 41.70 | 42.52 | 44.72 |
| Y₂O₃, ZrO₂, and La₂O₃ | | | | | | | | |
| Refractive Index | 1.834 | 1.858 | 1.878 | 1.9 | 1.919 | 1.938 | 1.95 | 1.951 |
| Density (g/cm³) | 3.697 | 3.718 | 3.78 | 3.792 | 3.826 | 3.870 | 4.209 | 4.218 |
| Young's Modulus (GPa) | 108.1 | 109.8 | 112.8 | 112.6 | 115.3 | 116.5 | 106.1 | 103.3 |
| Shear Modulus (GPa) | 42.3 | 43.0 | 44.1 | 44.1 | 45.0 | 45.4 | 41.7 | 40.20. |
| Poisson's Ratio | 0.278 | 0.277 | 0.279 | 0.278 | 0.281 | 0.284 | 0.285 | 0.286 |

As indicated by the example glass compositions in Table 1, glass compositions and the resultant glass articles as described herein have increased refractive index and low density such that the glass compositions and the resultant glass articles are more efficient at bending light while reducing size and weight.

As seen in Tables 1 and 2, when the cumulative index-driving content (sum of TiO₂, Nb₂O₃, Ta₂O₅, Y₂O₃, ZrO₂, and La₂O₃) is less than the specified limit of 47 mol. %, the refractive index fails to meet the criteria of greater than or equal to 1.97. As exemplified, the relatively high refractive indices are, at least partially, the result of the relatively high cumulative index-driving content. For example, E1-E52 and E63-E79 contained at least 47 mol. % of TiO₂, Nb₂O₃, Ta₂O₅, Y₂O₃, ZrO₂, and La₂O₃ and had a refractive index greater than or equal to 1.97. In contrast, comparative examples C1-C8 included 20 mol. %, 32.8 mol. %, 34.9 mol. %, 37.07 mol. %, 39.8 mol. %, 41.7 mol. %, 42.52 mol. %, and 44.72 mol. %, respectively, of TiO₂, Nb₂O₃, Ta₂O₅, Y₂O₃, ZrO₂, and La₂O₃ and none achieved a refractive index greater than or equal to 1.97.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass composition comprising:
greater than or equal to 35 mol. % and less than or equal to 62 mol. % TiO₂;
greater than or equal to 6 mol. % and less than or equal to 30 mol. % SiO₂;
greater than or equal to 1 mol. % and less than or equal to 30 mol. % BaO; and
greater than or equal to 1 mol. % and less than or equal to 25 mol. % SrO, wherein:
the glass composition is free or substantially-free of B₂O₃;
a sum of TiO₂, Nb₂O₃, Ta₂O₅, Y₂O₃, ZrO₂, and La₂O₃ is greater than or equal to 47 mol. %,
RO is greater than or equal to 20 mol. % and less than or equal to 50 mol. %, wherein RO is the sum of BaO, SrO, and CaO; and
a total sum of concentrations of oxide components in the glass composition is equal to 100 mol. %.

2. The glass composition of claim 1, wherein the glass composition is free or substantially-free of P₂O₅.

3. The glass composition of claim 1, wherein the glass composition comprises greater than or equal to 36 mol. % and less than or equal to 60 mol. % TiO₂.

4. The glass composition of claim 1, wherein the sum of TiO₂, Nb₂O₃, Ta₂O₅, Y₂O₃, ZrO₂, and La₂O₃ is greater than or equal to 48 mol. %.

5. The glass composition of claim 1, wherein the glass composition comprises greater than or equal to 0.1 mol. % and less than or equal to 12 mol. % Nb₂O₃.

6. The glass composition of claim 1, wherein the glass composition comprises greater than or equal to 0.1 mol. % and less than or equal to 12 mol. % Ta₂O₅.

7. The glass composition of claim 1, wherein the glass composition comprises greater than or equal to 0.1 mol. % and less than or equal to 12 mol. % Y₂O₃.

8. The glass composition of claim 1, wherein the glass composition comprises greater than or equal to 0.1 mol. % and less than or equal to 12 mol. % ZrO₂.

9. The glass composition of claim 1, wherein the glass composition comprises greater than or equal to 0.1 mol. % and less than or equal to 12 mol. % La₂O₃.

10. The glass composition of claim 1, wherein RO is greater than 25 mol. % and less than or equal to 40 mol. %.

11. The glass composition of claim 1, wherein the glass composition comprises greater than or equal to 6 mol. % and less than or equal to 25 mol. % BaO.

12. The glass composition of claim 1, wherein the glass composition comprises greater than or equal to 2 mol. % and less than or equal to 23 mol. % SrO.

13. The glass composition of claim 1, wherein the glass composition comprises greater than 0 mol. % and less than or equal to 15 mol. % CaO.

14. The glass composition of claim 1, wherein the glass composition comprises greater than or equal to 10 mol. % and less than or equal to 23 mol. % SiO₂.

15. The glass composition of claim 1, wherein the glass composition comprises:
greater than or equal to 37 mol. % and less than or equal to 52 mol. % TiO₂;
greater than or equal to 18 mol. % and less than or equal to 23 mol. % SiO₂;
greater than or equal to 8 mol. % and less than or equal to 25 mol. % BaO; and
greater than or equal to 2 mol. % and less than or equal to 20 mol. % SrO.

16. A glass article comprising the glass composition of claim 1, wherein the glass article comprises:
a refractive index (n_{d}) at 589.3 nm greater than or equal to 1.97, and
a density less than 4.8 g/cm³.

17. A glass composition comprising:
greater than or equal to 38 mol. % and less than or equal to 50 mol. % TiO₂;
greater than or equal to 19 mol. % and less than or equal to 22 mol. % SiO₂;
greater than or equal to 10 mol. % and less than or equal to 20 mol. % BaO; and
greater than or equal to 2 mol. % and less than or equal to 17 mol. % SrO, wherein:
the glass composition is free or substantially-free of B₂O₃;
a sum of TiO₂, Nb₂O₃, Ta₂O₅, Y₂O₃, ZrO₂, and La₂O₃ is greater than or equal to 49 mol. %,
RO is greater than or equal to 27 mol. % and less than or equal to 31 mol. %, wherein RO is the sum of BaO, SrO, and CaO; and
the sum of all oxide components is equal to 100 mol. %.

18. A glass composition comprising:
greater than or equal to 35 mol. % and less than or equal to 62 mol. % TiO₂;
greater than or equal to 6 mol. % and less than or equal to 30 mol. % SiO₂;
greater than or equal to 1 mol. % and less than or equal to 30 mol. % BaO;
greater than or equal to 1 mol. % and less than or equal to 25 mol. % SrO; and
greater than or equal to 0 mol. % and less than 10 mol. % B₂O₃, wherein:
a sum of TiO₂, Nb₂O₃, Ta₂O₅, Y₂O₃, ZrO₂, and La₂O₃ is greater than or equal to 47 mol. %,
RO is greater than or equal to 20 mol. % and less than or equal to 50 mol. %, wherein RO is the sum of BaO, SrO, and CaO; and
a total sum of concentrations of oxide components in the glass composition is equal to 100 mol. %.

19. The glass composition of claim 18, wherein the glass composition is free or substantially-free of P₂O₅.

20. The glass composition of claim 18, wherein the glass composition comprises greater than or equal to 36 mol. % and less than or equal to 60 mol. % TiO₂.
